(19) United States
(12) Patent Application Publication
(10) Pub. No.: US 2025/0122107 A1
(43) Pub. Date: Apr. 17, 2025

(54) FREE CHLORINE MAINTAINED SYSTEMS

(71) Applicant: King Technology, Inc., Minnetonka, MN (US)

(72) Inventors: Daniil A. Rezekulov, Savage, MN (US); David Guy, Maple Grove, MN (US); Jeffrey D. Johnson, Edina, MN (US); Paul Freeberg, South St. Paul, MN (US); Terry Goeman, Minnetonka, MN (US); Lyle Enderson, Anoka, MN (US); Joseph A. King, Wayzata, MN (US); Randy Roseth, Chanhassen, MN (US)

(21) Appl. No.: 18/649,442

(22) Filed: Apr. 29, 2024

Related U.S. Application Data
(63) Continuation-in-part of application No. 17/803,361, filed on May 31, 2022, now Pat. No. 11,999,637.
Application No. 17/803,361 is a division of application No. 17/300,204, filed on Apr. 12, 2021, now Pat. No. 11,629,078.
Application No. 17/300,204 is a division of application No. 16/602,276, filed on Sep. 5, 2019, now Pat. No. 11,203,539.
(60) Provisional application No. 62/765,681, filed on Sep. 7, 2018.

(51) Int. Cl. C02F 1/68; C02F 1/76

(52) U.S. Cl. CPC C02F 1/685; C02F 1/76

(57) ABSTRACT

A method of maintaining a safe free chlorine level in a body of water for recreational use where the free chlorine level at a harmful level comprises determining if the free chlorine level in the body of water is above a safe level and adding sufficient DMH to the body of water to bring the free chlorine down to a safe level.

### RELATED APPLICATIONS

This application is a continuation-in-part of U.S. Ser. No. 17/803,361 filed May 31, 2022, which is a division of U.S. Ser. No. 17/300,204 filed Apr. 12, 2021 and now U.S. Pat. No. 11,629,078 issued on Apr. 18, 2023, which is a division of U.S. Ser. No. 16/602,276 filed Sep. 5, 2019 and now U.S. Pat. No. 11,203,539 issued on Dec. 21, 2021, which claims priority to U.S. Provisional Application 62/765,681, filed Sep. 7, 2018, the entire contents of which are incorporated herein by reference.

### TECHNICAL FIELD

This disclosure relates to methods of maintaining free chlorine levels in a body of water and more particularly to maintaining free chlorine levels in a body of water with 5,5-dimethylhydantoin (DMH) when subject to a condition that decreases free chlorine level in the body of water.

### BACKGROUND

One of the difficulties in using chlorine for maintaining a body of recreational water at a person friendly condition i.e., such as a pool or hot tub, is that if the free chlorine level is too high it can be harmful to the persons in the body of recreational water. On the other hand, if the free chlorine level is too low, the pathogens in the body of recreational water can be harmful to the persons in the body of recreational water. Typically, chlorine is continually added to a body of water such as a pool or spa in a variety of ways, for example, through a floating dispenser or an inline dispenser that contains chlorine in a solid form. In these types of dispensers, the rate of delivery of chlorine is manually set to accommodate an expected load on the pool and is periodically adjusted based on tests on the amount of chlorine in the water.

One of the difficulties with free chlorine maintenance in a system is the need to maintain the body of water in a person friendly condition even though the body of water is subject to periodic bather loads or environmental conditions, which consumes available free chlorine and, therefore, lessens the capacity of the system to rid the body of water of harmful pathogens. Consequently, maintaining a body of recreational water in a person friendly condition usually requires adding additional chlorine to the body of water to replace the free chlorine consumed in ridding the water of harmful pathogens.

Various methods are used to maintain an acceptable level of free chlorine in the body of water as the demand for free chlorine varies in response to a bather load. One method uses electrolytic cells that generate additional chlorine. Another method uses dispensers that can be adjusted to dispense additional chlorine into the body of water in response to an increased bather load while still other methods may supplement the free chlorine with other chemicals or metallic ions to maintain the body of recreational water at a person friendly condition i.e., where the free chlorine in the body of water continues to rid the water of harmful pathogens even though the body of recreational water is subject to a periodic bather load. Typically, such systems require the pool owner to manually adjust the chlorine-dispensing rate before and after pool events if the pool owner wants to maintain the body of water in a person friendly condition.

For bodies of water that are maintained outdoors, various environmental conditions may further affect the lifespan of chlorine in the body of water. For example, ultraviolet radiation from sunlight has been shown to reduce the lifespan of chlorine within recreational bodies of water. Current chemistries for protecting chlorine from the effects of UV include the use of cyanuric acid (CYA). However, among other drawbacks, CYA can build up in a body of water, making it difficult to remove unless the body of water is further diluted. Therefore, there remains a need for compositions and methods for maintaining chlorine in a body of water, including under conditions that decrease the free chlorine level.

### SUMMARY

A free chlorine maintained system and a method of maintaining a free chlorine level in a body of water as the free chlorine is consumed, with the disclosure further including a free chlorine maintainer, which is self-regulating, for maintaining a free chlorine level in a body of recreational water for human immersion with the free chlorine level in the body of water maintained at sufficiently low concentration to avoid chlorine harm to a person in the body of water and at sufficiently high concentration to control the pathogens in the body of recreational water at a safe level for human immersion even though the body of water is subject to periodic bather loads. It has been found that the addition of 5,5-dimethyl-hydanteoin (DMH), which is classified as an inert product since it contains no antimicrobial properties, produces a self-correcting effect in response to increased chlorine requirements caused by periodic bather loads on a pool. While not fully understood, it is believed the system temporarily neutralizes chlorine being dispensed to the pool when the chlorine demand in the pool is normal and releases the neutralized chlorine in the form of free chlorine in response to an abnormal chlorine load to thereby eliminate the need to periodically add additional chlorine to the body of water in response to periodic bather loads. A further feature of the disclosure is that when the DMH is used in an outdoor body of water, the DMH can be accompanied by an algaecide to further maintain the body of water free of algae in response to periodic bather loads. In order to maintain the self-correcting effect in response to periodic bather loads, DMH is periodically added to the body of water.

In further embodiments, a method of maintaining a free chlorine level in a body of water when subject to a condition that decreases the free chlorine level is provided. A chlorinating agent may be added to the body in addition to DMH at an initial weight ratio of total chlorine level in the body of water to the DMH in the body of water in a range of about 1:100 to about 4:5. In some aspects, the free chlorine level in the body of water can be maintained at a concentration of less than about 40% of the total chlorine level. In further aspects, the condition may be an environmental condition, including, but not limited to UV radiation, precipitation, changes in temperature, or presence of organic matter.

While multiple embodiments are disclosed, still other embodiments of the present disclosure will become apparent to those skilled in the art from the following detailed description, which shows and describes illustrative embodiments of the disclosure. Accordingly, the figures and detailed description are to be regarded as illustrative in nature and not restrictive.

### BRIEF DESCRIPTION OF DRAWINGS

Various embodiments of the present disclosure will be described in detail with reference to the figures. Reference to various embodiments does not limit the scope of the disclosure. Figures represented herein are not limitations to the various embodiments according to the disclosure and are presented for exemplary illustration of the disclosure.

FIG. 1 is a table of the chlorine content in a 400-gallon Hot Springs Vanguard spa containing tap water and chlorine where the chlorine is obtained from Sodium Dichloroisocyanurate-dihydrate (Dichlor) and the pH of the water has been adjusted by adding pH down (sodium Bisulfate) to the tap water.

FIG. 2 is a graph of the free chlorine in the 400-gallon Hot Springs Vanguard spa as a function of time with the spa having been subjected to a bather load and with the free chlorine in the water obtained from Sodium Dichloroisocyanurate-dihydrate.

FIG. 2A is a graph of the free chlorine in the 400-gallon Hot Springs Vanguard spa as a function of time with the spa having been subjected to a bather load and with the spa water containing 5,5-dimethyl-hydanteoin (DMH) and free chlorine obtained from Sodium Dichloroisocyanurate-dihydrate.

FIG. 3 is a graph of the free chlorine in the 400-gallon Hot Springs Vanguard spa as a function of time with the spa having been subjected to a bather load with the water in the spa containing Sodium Dichloroisocyanurate-dihydrate but no DMH.

FIG. 3A is a graph of the free chlorine and total chlorine in the 400-gallon Hot Springs Vanguard spa as a function of time with the spa having been subjected to a bather load with the water in the spa containing both Sodium Dichloroisocyanurate-dihydrate and DMH.

FIG. 4 is a table of the contents of a 300-gallon Marquis Destiny Spa containing tap water, Dichlor, DMH and pH down.

FIG. 5 is a graph of the free chlorine and total chlorine as a function of the amount of DMH in the 300-gallon Marquis Destiny Spa.

FIG. 6 shows a dispenser partly in section with the dispenser containing a chlorinating agent and DMH for placement of the dispenser directly in a body of water.

FIG. 7 shows a two part dispensing system for separate placement of a chlorinating agent and DMH into a body of water with each dispenser partly in section.

FIG. 8 is a perspective view showing a dispersal valve for normally and controllable dispersing multiple water treatment dispersants into a body of recreational water.

FIG. 8A shows a kit.

FIG. 9 shows a partial cutaway perspective view of an annular nestable canister supporting water treatment minerals therein for use in the dispersal valve of FIG. 8.

FIG. 10 shows a partial cutaway side view of a second nestable canister containing a chlorinating agent therein for use in the dispersal valve of FIG. 8.

FIG. 11 is a blowout view showing the second nestable canister of FIG. 10 axially inserted within the nestable canister of FIG. 9 for use in the dispersal valve of FIG. 8.

FIG. 12 shows a partial cutaway side view of a second nestable canister quickly dispensable DMH therein for use in the dispersal valve of FIG. 8.

FIG. 13 shows a partial cutaway side view of a second nestable canister containing an immediate dispensable algaecide therein for use in the dispersal valve of FIG. 8.

FIG. 14A is a graph showing the percent of total chlorine (TCl) remaining over a period of 0 hours to 7 hours for various formulations, including baseline (chlorine alone), DMH (30 ppm), cyanuric acid (CYA; 30 ppm), CYA (50 ppm), CYA (75 ppm), and DMH+CYA (30 ppm of each).

FIG. 14B is a graph showing the effects of either chlorine+DMH, or chlorine+DMH+CYA on the free chlorine level concentration in ppm within a body of water as measured over a period of 0 hours to about 60 hours.

FIG. 14C is a graph showing the effects of various formulations on the TCl level in the body of water over a period of 0 hours to about 60 hours. The formulations evaluated included a DMH sample (chlorine+30 ppm DMH) with UV exposure, a DMH sample (chlorine+30 ppm DMH) without UV exposure, CYA sample (chlorine+75 ppm CYA) with UV exposure, and DMH+CYA sample (chlorine and 30 ppm DMH+75 ppm CYA) with UV exposure.

FIG. 15A shows a graph of the effects of higher concentrations of TCl level in a body of water on the decomposition time of DMH at 20 ppm as measured over a period of 0 days to about 35 days. The graph further shows the results of the FCl level within the body of water.

FIG. 15B shows a graph of the effects of TCl level in a body of water on the decomposition time of DMH at 10 ppm as measured over a period of 0 days to about 35 days. The graph further shows the results of the FCl level within the body of water.

FIG. 15C is a graph showing the effects of TCl concentration level on FCl concentration level within a body of water containing 80 ppm of DMH. The graph shows the chlorine levels over a period of 6 days.

FIG. 15D is a graph showing the effects of TCl concentration level on FCl concentration level within a body of water containing 80 ppm of DMH. The graph shows the chlorine levels over a period of 20 days.

FIG. 16A shows a graph of the relationship between the TCl concentration and FCl concentration as a percentage of the TCl concentration within a hot tub, comparing a hot tub having a salt chlorine generator without DMH versus a hot tub having a salt chlorine generator with DMH.

FIG. 16B shows a graph of the relationship between the TCl concentration and FCl concentration as a percentage of the TCl concentration within a pool having 30 ppm of DMH. Several bleach loads were added to the pool weekly.

### DETAILED DESCRIPTION

The embodiments of this disclosure are not limited to particular methods of maintaining chlorine in a body of water which can vary and are understood by skilled artisans. It is further to be understood that all terminology used herein is for the purpose of describing particular embodiments only and is not intended to be limiting in any manner or scope. So that the present disclosure may be more readily understood, certain terms are first defined. Unless defined otherwise, all technical and scientific terms used herein have the same meaning as commonly understood by one of ordinary skill in the art to which embodiments of the disclosure pertain. Many methods and materials similar, modified, or equivalent to those described herein can be used in the practice of the embodiments of the present disclosure without undue experimentation, the preferred materials and methods are described herein. In describing and claiming the embodiments of the present disclosure, the following terminology will be used in accordance with the definitions set out below.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range.

The term “about,” as used herein, refers to variation in the numerical quantity that can occur, for example, through typical measuring techniques and equipment, with respect to any quantifiable variable, including, but not limited to, mass, volume, temperature, and time. Further, given solid and liquid handling procedures used in the real world, there is certain inadvertent error and variation that is likely through differences in the manufacture, source, or purity of the ingredients used to make the compositions or carry out the methods and the like. Whether or not modified by the term “about,” the claims include equivalents to the quantities.

As described herein throughout the disclosure, a free chlorine (FCl) maintainable system is provided, which is self-regulating, for maintaining a free chlorine level in the body of recreational water sufficiently low to avoid chlorine harm to a person in the body of water and sufficiently high to control the pathogens in the body of water at a safe level when the body of water is subject to periodic bather loads while minimizing or eliminating the need to supply additional disinfectants to the body of water in response to the periodic bather loads. A body of recreational water as used herein, although not limited to, is understood to comprise a body of water such as a pool, a spa, a hot tub, or the like in which a person wholly or partially immerses himself or herself. While the disclosure described herein is suitable for use in various bodies of water, it is in some embodiments well suited for seasonal outdoor pools where the chlorine needs of the outdoor pool can vary for a variety of reasons, including bather load and environmental loads.

In some aspects, it has been found that a free chlorine maintained system of recreational water using a free chlorine maintainer comprising chlorine and dimethylhydantoin (DMH) while the physical conditions of the recreational water such as the temperature, the alkalinity, and the pH, are kept within limits acceptable for recreational use, can maintain the body of recreational water in a safe condition for recreational uses. The free chlorine maintained system allows the free chlorine in the body of water to attack the pathogens from the bather load while also preventing the free chlorine level in the body of water from dropping to an unsafe level, typically less than about 0.5 ppm to about 0.1 ppm.

The disclosure includes multiple ways of obtaining a water system that avoids the drop off in free chlorine levels when the water is subjected to a bather load or other condition that decreases free chlorine levels, such as, but not limited to, environmental conditions. In some examples, the present disclosure described herein comprises a method of maintaining the free chlorine in a body of water for human immersion in a range of about 0.5 ppm to about 1 ppm when subject to a bather load that decreases the free chlorine available in the body of water. In some embodiments, the disclosure comprises the steps of adding a chlorinating agent to overcome the initial sanitizing chlorine demand of the body of water and maintaining a temperature of the body of water in a range of about 70° F. to about 104° F. If needed, one can adjust the alkalinity of the body of water in a range of about 80 ppm to about 120 ppm by adding sodium bisulfate. Preferably one should maintain the pH in the body of water in the range of about 7.2 to about 7.8.

In some aspects, chlorine may be added to the body of water to bring the total chlorine level in the body of water in a range of about 1 ppm to about 20 ppm. In some examples, it has been found that if DMH is added to the body of water, the level of free chlorine can be brought to about 1 ppm as the addition of DMH has been found to lower the measurable free chlorine until a stable or equilibrium state of about 1.0 ppm is obtained. Once the initial chlorine conditions of the pool are established, a maintenance amount of chlorine can be continually or intermittingly added to the body of water through a dispenser, or the like, to maintain the body of water in the initial condition for human recreational use. Typically, the rate of release of chlorine is manually selected on either an inline dispenser or an in-water dispenser in order to maintain a free chlorine base (typically 0.5 ppm to 1.0 ppm free chlorine) in the body of water sufficient to maintain the pool suitable for use by bathers. With the above-described chlorine base water condition maintained through a dispenser, which is not responsive to a bather load, it has been found that with the presence of DMH and chlorine in the body of water, one can subject the body of water to a normal bather load. Although the bather load spikes the need for free chlorine, the use of DMH and chlorine prevents the free chlorine level from dropping to an unacceptable level. In aspects, it has been found that while the bather load absorbs free chlorine in the body of water, with the presence of DMH, the level of free chlorine is prevented from decreasing to less than 0.5 ppm. A normal bather load as described herein is bather use that is unique to a particular pool use and may be different for another pool. For example, some pools may have two persons using the pool on a regular basis while other pools may have six or seven people using the pool on a regular basis. In each case once the base level of chlorine has been established the use of chlorine in combination with the DMH can be used to provide a buffer to maintain the pool water in a person friendly condition even though the bather load has spiked the need for additional chlorine to accommodate the effects of the bathers in the pool.

One of the features of the disclosure is that the addition of DMH to the body of recreational water, which contains chlorine, causes the free chlorine level in the body of water to reach an equilibrium state even though the temperature of the body of water may range from about 70° F. to about 104° F. Once the equilibrium state is reached, the free chlorine as well as the total chlorine in the body of recreational water has been found to remain constant as the amount of DMH is increased.

In further embodiments, once the body of water is prepared for human use, a sufficient amount of DMH is added to the pool water to bring the DMH concentration in the pool up to 200 ppm. While more or less DMH may be used, it is preferred to have at least 200 ppm since the DMH eventually degrades during pool use. Typically, under most pool use, an initial dose of 200 ppm of DMH lasts about 30 days. It is noted that it is further preferred to have the DMH concentration in the pool maintained between 20 ppm and 200 ppm, which may also be referred to as a “working” concentration or of DMH.

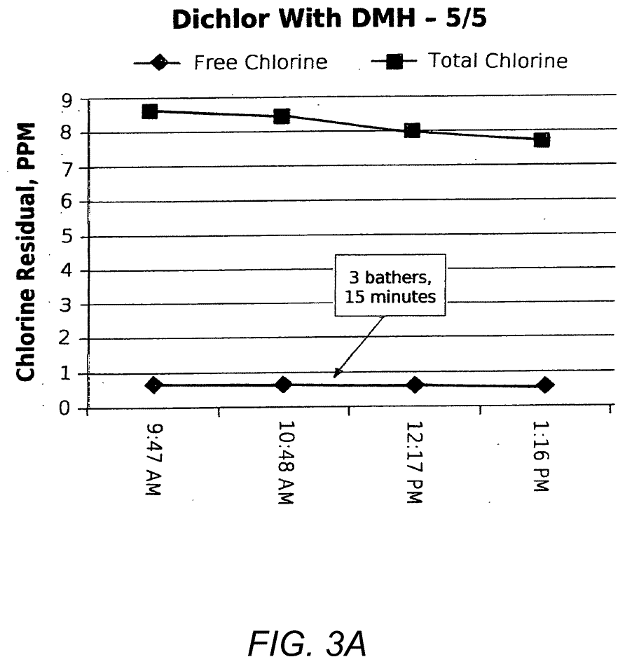

In embodiments, chlorine is added to the body of water containing the DMH to bring the total chlorine (TCl) level up to at least 5.0 ppm, which has been found to raise the level the free chlorine in the water to a range of about 0.5 to about 1.0 ppm. Chlorine may be added to the water in several different ways, including but not limited to, chlorinating agents comprising liquid bleach (NaClO), calcium hypochlorite (Ca(ClO)), or trichloroisocyanauric acid (C₃Cl₃N₃O₃). In further aspects, the chlorinating agent may comprise or result from liquid bleach, calcium hypochlorite, trichloroisocyanuric acid, an electrolytic cell that generates chlorine, chlorine gas, lithium hypochlorite, sodium dichloro-S-Triazinetrione, or a combination thereof. An unknown relationship exists between the chlorine and the DMH that causes the free chlorine in the pool to be stabilized and be maintained between levels in the range of about 0.5 ppm to about 1.0 ppm, as shown in FIG. 5, for example. In addition, although the free chlorine level may be maintained between about 0.5 ppm and about 1.0 ppm, it has been found that the likely relationship between the DMH and the attached or combined chlorine in the body of water forms a reservoir of chlorine that can be used to compensate for the excess free chlorine use required by a periodic chlorine load on the pool or a condition that decreases the free chlorine level. For example, by periodic load, it is understood to include a need for additional free chlorine to compensate for the use of a pool, for example, by a group of people although other types of periodic loads, which consume chlorine, may also be compensated for with the disclosure described herein. In further examples, the condition that decreases the free chlorine level may be an environmental condition, including, but not limited to, UV radiation, precipitation, changes in temperature, or presence of organic matter. In some embodiments, the environmental condition is UV radiation which can accelerate the degradation of chlorine in a body of water.

In further steps, an operator can adjust the chlorine dispenser to deliver a constant rate of chlorine into the pool or body of water. The delivery of a constant rate of chlorine is intended to balance the ongoing needs of the pool or body of water as it responds the external environment and is considered a base level to handle the typical ongoing chlorine needs of the pool.

During use of the pool or body of water, the operator may periodically test the level of chlorine and adjust the rate of chlorine release from a dispenser in the event the ongoing chlorine needs of the pool changes. For example, the ongoing chlorine needs of the pool may change due to sunlight or organic debris that may enter the pool, such as but not limited to after a storm. These types of changes in chlorine needs are considered long-term changes and are compensated typically through a manual adjustment of the amount of chlorine delivered to the pool. In some aspects, DMH may be added to the body of water to prevent or reduce the rate of decomposition of the chlorine within the body of water when subject to a condition that decreases the free chlorine level. Beneficially, adding DMH to a body of water can prolong the percent of total chlorine remaining in a body of water when exposed to a condition that decreases the free chlorine level, such as, for example, UV radiation, precipitation, changes in temperature, or presence of organic matter, in comparison to the same body of water without DMH.

After a set period (about 30 days preferred) additional DMH may be needed to be added to the pool or body of water to bring the concentration of DMH in the pool back to a “working” concentration or the effect of maintaining a reservoir of free chlorine is lost as the DMH decreases with time. In some aspects, because the DMH effectiveness in neutralizing the free chlorine may decrease, it may be necessary to replenish the DMH after a period of time. The pool with the DMH is now set to handle the periodic spikes or loads on the pool due to periodic bather use or a condition that decreases the free chlorine level.

Under some conditions, the algae growth in a pool or body of water may cause an increase in free chlorine use that cannot be overcome by a chlorine reservoir, such as, for example, an attached chlorine-DMH reservoir. At this point an algaecide may be added to the pool or body of water.

A feature of the disclosure described herein is that there are a number of ways to obtain a free chlorine maintained system. A free chlorine maintainer, which comprises a chlorinating agent and DMH, can be separately introduced into the body of recreational water for the in situ formation of the free chlorine maintainer in the body of water, which may include recreational water. In some examples, DMH is added to the body of water followed by the addition of a chlorinating agent until the chlorine reaches an equilibrium state at about 1 ppm. In another example, chlorine is added to the body of recreational water followed by the addition of sufficient DMH to bring the chlorine into an equilibrium state, which is about 1 ppm. In still another example, the DMH and chlorine agent may be simultaneously delivered to the body of water either in bulk form or through a container that is thrown or placed in the body of water, for example, a container that dissolves in the body of water to release the chlorinating agent and DMH. In some embodiments, the chlorinating agent may be added to the body of water before and/or after adding the DMH to the body of water. In other embodiments, the DMH may be added to the body of water before and/or after adding of the chlorinating agent to the body of water. Thus, there are multiple ways one can obtain a free chlorine maintained system.

Typically, sufficient chlorinating agent should be added to the body of water to bring the free chlorine level in the body of water to at least 1.0 ppm but less than 20 ppm. Subsequently, sufficient dimethylhydantoin (DMH) should be added to the body of water to bring the free chlorine level in the body of water to an equilibrium state of about 1.0 ppm. Typically, adding sufficient DMH to bring the DMH concentration in the body of water to at least 20 ppm results in a free chlorine equilibrium state ranging from about 0.5 ppm to 1.0 ppm. In some aspects, increasing the concentration of DMH in the body of water from 20 ppm to 200 ppm has not been found to reduce the free chlorine equilibrium in the body of water.

In one method of the disclosure, DMH is separately added to the body of water followed by the separate addition of the chlorinating agent. It has been found that both the DMH and free chlorine in the body of water degrade with time. One method of maintaining the body of water is to periodically add DMH and chlorine to the body of water. This maintenance additions of DMH and chlorine may be done separately or at the same time.

The disclosure further provides for a method of maintaining the free chlorine in a body of water for human immersion between 0.5 ppm and 1.0 ppm while other features of the water are maintained as the water is subject to a bather load or condition that normally decreases the free chlorine. In further embodiments, the methods provided herein with the administration of DMH to the body of water further include maintaining the free chlorine level in the body of water at a concentration of less than about 40% of the total chlorine level. For example, the free chlorine level may be maintained at a concentration of less than about 38%, less than about 35%, or less than about 30% of the total chlorine level. In embodiments, the free chlorine level may be maintained at a concentration of less than about 40% and at least about 2%. In some aspects, a chlorinating agent may be added to overcome the initial sanitizing chlorine demand of the body of water. In embodiments, a temperature of the body of water may be maintained in the range of about 70° F. to about 104° F. while it is preferred to adjust the alkalinity of the body of water to a range of about 80 ppm and about 120 ppm, for example, by adding sodium bisulfate. It is also for comfort it is preferred to maintain the pH in the body of water in the range of about 7.2 to about 7.8. In embodiments, chlorine may be added to the body of water via a chlorinating agent, thereby contributing to a total chlorine level in the body of water. In some embodiments, chlorine may be added to the body of water to bring the total chlorine level in the body of water to a range of about 1 ppm to about 20 ppm and adding DMH to the body of water to bring the level of free chlorine down to about 1.0 ppm. In further embodiments, the DMH may be added to the body of water in an initial weight ratio of the total chlorine level in the body of water to the DMH in the body of water in a range of about 1:100 to about 4:5, including, for example, in the range of about 1:100 to about 3:4, about 1:100 to about 7:10, about 1:100 to about 13:20, about 1:100 to about 3:5, or about 1:100 to about 11:20. In further embodiments, the weight ratio of the total chlorine level in the body of water to the DMH in the body of water is maintained at about 11:20 or less.

In some aspects, the ratios of the total chlorine level in the body of water to the DMH in the body of water may beneficially decrease the decomposition or rate of decomposition of the DMH in the body of water. For example, the total saturation point of DMH with chlorine may be around 0.55, or at a weight ratio of total chlorine to DMH of around 11:20. Therefore, maintaining a ratio less than 11:20 may decrease the decomposition rate of DMH. However, a higher weight ratio than 11:20 may also be maintained in embodiments where higher free chlorine levels are intended, while still maintaining a reservoir of chlorine that can be used to compensate for the excess free chlorine use required by a periodic chlorine load on the pool or a condition that decreases the free chlorine level.

In some aspects, the weight ratio of total chlorine to DMH as described herein allows for subjecting the body of water to a normal bather load or other type of normal load, such as from rain. In some aspects, the typical load placed on the body of water, which absorbs free chlorine in the body of water, has been found to not decrease the free chlorine to less than about 0.5 ppm. As described herein, the typical load for a body of water may vary and, consequently, the time between additions of chlorine may vary from spa to spa. For example, in some cases, the free chlorine level may reside at appropriate levels for a period of months based on the typical bacterial load and in other cases the free chlorine level may last for a period of weeks due to the heavier bacterial load. In each case, the primary determination of the additional length of time that the system maintains itself at a safe free chlorine level may be determined by the bacterial load normally experienced by the body of water.

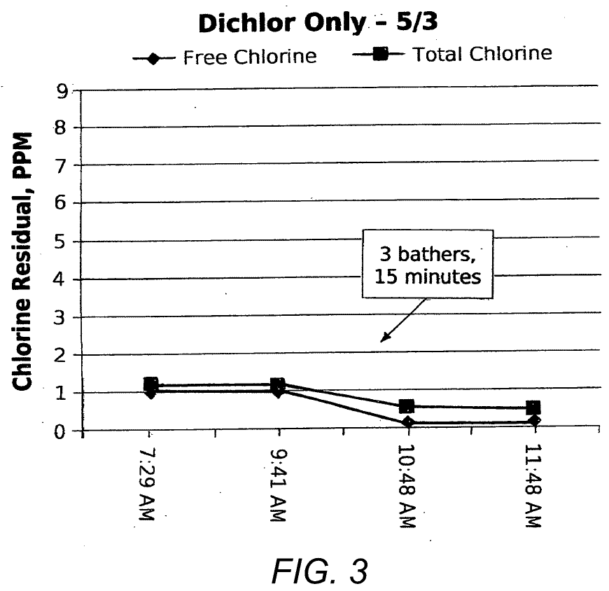

A feature of the disclosure described herein is that in systems where the free chlorine has been purposely or accidentally raised to levels that are considered harmful for recreational use, which some sources indicates as being as low as 2.5 ppm, the body of water can be rendered suitable for recreational use through the addition of DMH to the body of water. In the examples as further described herein, and as shown in FIG. 4 and FIG. 5, the free chlorine level in the body of water may be lowered through the addition of DMH to the body of water. Note FIG. 4 shows a free chlorine level in excess of 10 ppm being lowered to 0.52 ppm through the addition of DMH to the body of water. Thus, the use of DMH becomes effective to reduce the level of free chlorine in a pool without having to increase the bacterial load on the pool.

In some embodiments, cyanuric acid may be further added to the body of water in addition to the DMH. In other embodiments, the cyanuric acid is further present in the body of water, or pre-existing in the body of water. In some examples, the cyanuric acid may be used for reducing the decomposition rate of chlorine within the body of water, including when the body of water is subject to a bather load or other condition that decreases the free chlorine level. Beneficially, having both DMH and CYA in the body of water provides a combination that maintains a higher concentration of the total chlorine level in the body of water compared with the same body of water when provided with an identical concentration of CYA but without the DMH. In some aspects, the DMH increases the efficacy of the CYA in the body of water in maintaining the free chlorine level in the body of water in the range of about 0.5 ppm to about 1 ppm when subject to the condition that decreases the free chlorine level. In embodiments where both of the DMH and cyanuric acid are present in the body of water, the weight ratio of the DMH to the CYA may be in a range of about 1:20 to about 10:1.

In one example the disclosure can comprise a one-shot prepackaged free chlorine maintainer for emptying into a body of water such as a spa or pool to maintain a free chlorine level in the body of water between 0.5 ppm and 1.0 ppm when the body of water is subject to a bather load with the free chlorine maintainer consisting of a chlorinating agent in solid form and DMH in solid form where a weight ratio of the DMH to the chlorinating agent in the body of water is at least 0.5. In other embodiments, and as further described herein, the initial weight ratio of the total chlorine level in the body of water to the DMH in the body of water is in a range of about 1:100 to about 4:5.

While the chlorinating agent may comprise sodium dichlorocyanurate dihydrate, other chlorinating agents may be used to establish the free chlorine level in the body of water. For example, a chlorinating agent selected from the group consisting of both organic and inorganic agents including trichloroisocyanauric acid, potassium dichloroisocyanurate, dichlorocyanurate dihydrate, calcium hypochlorite, lithium hypochlorite and sodium hypochlorite. In further examples, the chlorinating agent may comprise or result from liquid bleach, calcium hypochlorite, trichloroisocyanuric acid, an electrolytic cell that generates chlorine, chlorine gas, lithium hypochlorite, sodium dichloro-S-Triazinetrione, or a combination thereof.

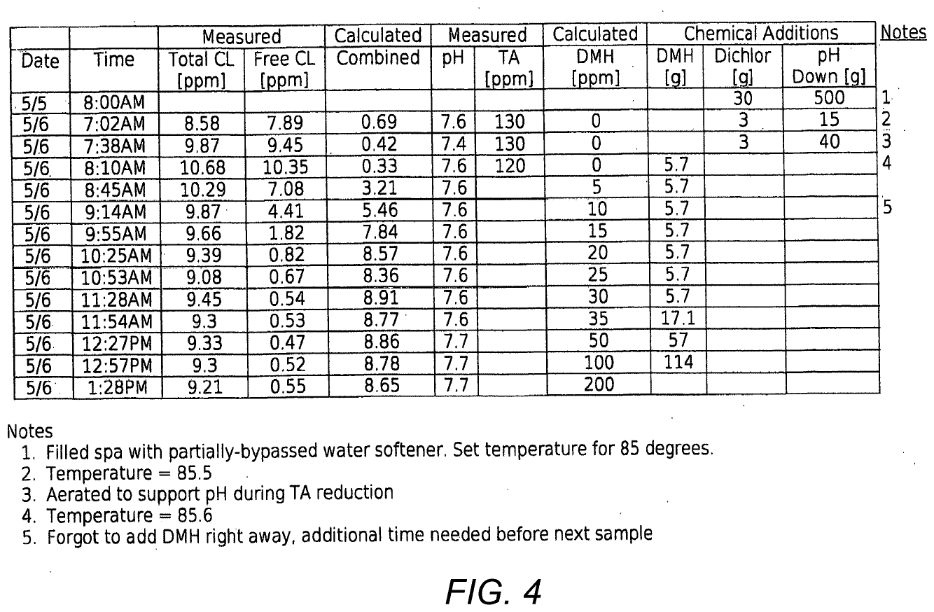

FIG. 6 shows a prepackaged free chlorine maintainer for emptying into a body of water to maintain free chlorine level in the body of water between 0.5 ppm and 1.0 ppm when the body of water is subject to a bather load with the free chlorine maintainer consisting of a chlorinating agent in solid form and DMH in solid form where a weight ratio of the DMH to the chlorinating agent in the body of water is at least 0.5. In other embodiments, and as further described herein, the initial weight ratio of the total chlorine level in the body of water to the DMH in the body of water is in a range of about 1:100 to about 4:5. In this example, the container 10 has a first compartment 10a that contains the chlorinating agent 11 with the container 10 having ports 14 for water access to the chlorinating agent therein and a second compartment 10b that contains DMH 12 with ports 15 therein to permit water access to the DMH therein. While the DMH and chlorinating agent are added from the same dispenser they also can be added separately and at different times and the chlorine may be added to the body of water either in solid or liquid form.

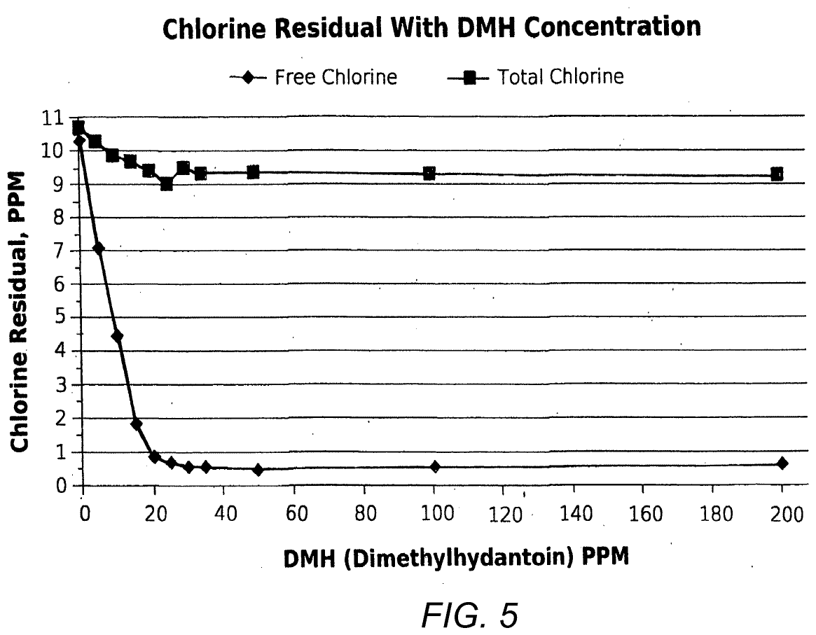

FIG. 7 shows another example of a spa product for maintaining the free chlorine level between 0.5 ppm and 1.0 ppm, or at a concentration of less than about 40% of the total chlorine level, in a body of water subject to a bather load with the spa product. In this example there is provided a first dispenser 30 having a compartment 31 containing a chlorinating agent 32 selected from the group consisting of trichloroisocyanauric acid, potassium dichloroisocyanurate, and sodium dichlorcyanurate with the dispenser having at least one port 30a for water access to the chlorinating agent therein when the dispenser 30 is placed in the body of water. In this example the spa product includes a second dispenser 33 with a compartment 35 containing dimethylhydantoin 34 with the second dispenser 33 having at least one port 33a for water access for release of the dimethylhydantoin into the body of water.

While the dispenser is shown as the type that are placed directly in the body of water the dispenser may be of the inline type that is placed in a dispenser where water is circulated through the dispenser. Examples of such dispensers are shown in King et al. U.S. Pat. Nos. 7,347,935 and 8,464,743, which are incorporated by reference in their entireties.

Various chemical chlorinating agents are disclosed herein that are dispensed into the body of water, however, in some instances, one may find it suitable to use a chlorine generator. While in-water dispensers are shown, one may want to use a bulk dispenser where the water is directed through a dispersant located in the bulk inline dispenser. Examples of bulk inline dispensers are shown in king U.S. Pat. No. 8,757,188, which is hereby incorporated by reference in its entirety.

Although not shown, the present disclosure may also comprise a swimming pool free chlorine maintaining kit for use in an inline dispenser of a swimming pool body of water that has been sanitized with a chlorinating agent to render the body of water safe for human immersion and subject to a periodic bather load and environmental conditions. The swimming pool free chlorine maintaining kit includes a first dispensing cartridge and a second dispensing cartridge each separately loadable into the inline dispenser of the swimming pool body of water.

The first dispensing cartridge includes a bottom inlet and a bottom outlet and contains an immediate dispensable or quickly dispensable DMH supported therein in sufficient amount to bring a DMH level in the swimming pool body of water to at least 20 ppm or at least 26 ppm. By immediate dispensable or quickly dispensable, it is meant that the DMH is completely dispensable into the swimming pool body of water within 30 minutes and preferably within 15 minutes.

The second dispensing cartridge includes a bottom inlet and a bottom outlet and contains a time dispensable chlorinating agent therein to bring the total chlorine level in a swimming pool body of water containing at least 20 ppm or at least 26 ppm DMH to between 3.0 and 10 ppm total chlorine with the concentration of DMH maintaining a free chlorine level in the swimming pool body of water to a range 0.5 ppm to 1.0 ppm free chlorine.

The swimming pool free chlorine maintaining kit may also include a third dispensing cartridge separately loadable into the inline dispenser of the swimming pool body of water with the third dispensing cartridge containing a time dispensable combination chlorinating agent and algaecide dispensable into the swimming pool body of water in response to a decrease of the free chlorine level in the swimming pool body of water to less than 0.5 ppm free chlorine to kill existing algae and control algae growth in the body of water while bringing the total chlorine level in the swimming pool body of water back to between 3.0 and 10 ppm.

The third dispensing cartridge may alternatively contain an immediate dispensable algaecide therein, the algaecide dispensable into the swimming pool body of water at the sign of algae growth to kill existing algae and control algae growth in swimming pool body of water.

The present disclosure also includes a method of maintaining the free chlorine in a body of water for human immersion between 0.5 ppm and 1.0 ppm when subject to a bather load and environmental conditions that decreases the free chlorine comprising the steps of (1) maintaining a temperature of the body of water between degrees 70° F. to 104° F., (2) sanitizing the body of water with a chlorinating agent to render the body of water safe for human immersion, (3) adjusting the alkalinity of the body of water to between 80 ppm and 120 ppm by adding either sodium bicarbonate to raise the alkalinity or muriatic acid to lower the alkalinity, (4) maintaining the pH in the body of water in the range of 7.2 to 7.8, (5) loading a first dispensing cartridge containing an immediate dispensable DMH therein into an inline dispenser of the body of water to bring a DMH level in the body of water to at least 26 ppm, (6) loading a second dispensing cartridge containing a time dispensable chlorinating agent therein into the inline dispenser of the body of water to bring the total chlorine level in a body of water containing at least 20 ppm or at least 26 ppm DMH to between 3.0 and 10 ppm total chlorine with the concentration of DMH maintaining a free chlorine level in the swimming pool body of water to a range 0.5 ppm to 1.0 ppm free chlorine, and then (7) subjecting the body of water to a bather load where the bather load consumes free chlorine and combined chlorine in the body of water without decreasing the free chlorine to less than 0.5 ppm level.

The above method of maintaining the free chlorine in a body of water for human immersion between 0.5 ppm and 1.0 ppm when subject to a bather load and environmental conditions that decreases the free chlorine may also include the steps of (8) loading a third dispensing cartridge containing a time dispensable combination chlorinating agent and algaecide therein into the inline dispenser of the body of water in response to a decrease of the free chlorine level in the body of water to less than 0.5 ppm free chlorine to kill existing algae and control algae growth in the body of water while bringing the total chlorine level in the body of water back to between 3.0 and 10 ppm, (9) loading a third dispensing cartridge containing an immediate dispensable algaecide therein into the inline dispenser of the body of water at the sign of algae growth water to kill existing algae and control algae growth in the body of water, (10) loading a third dispensing cartridge containing a time dispensable combination chlorinating agent and algaecide therein into the inline dispenser of the body of water at the sign of algae growth to kill existing algae and control algae growth in the body of water while bringing the total chlorine level in the body of water back to between 3.0 and 10 ppm, and (11) loading a third dispensing cartridge containing an immediate dispensable DMH therein into the inline dispenser of the body of water to bring the DMH level in the body of water up to at least 20 ppm.

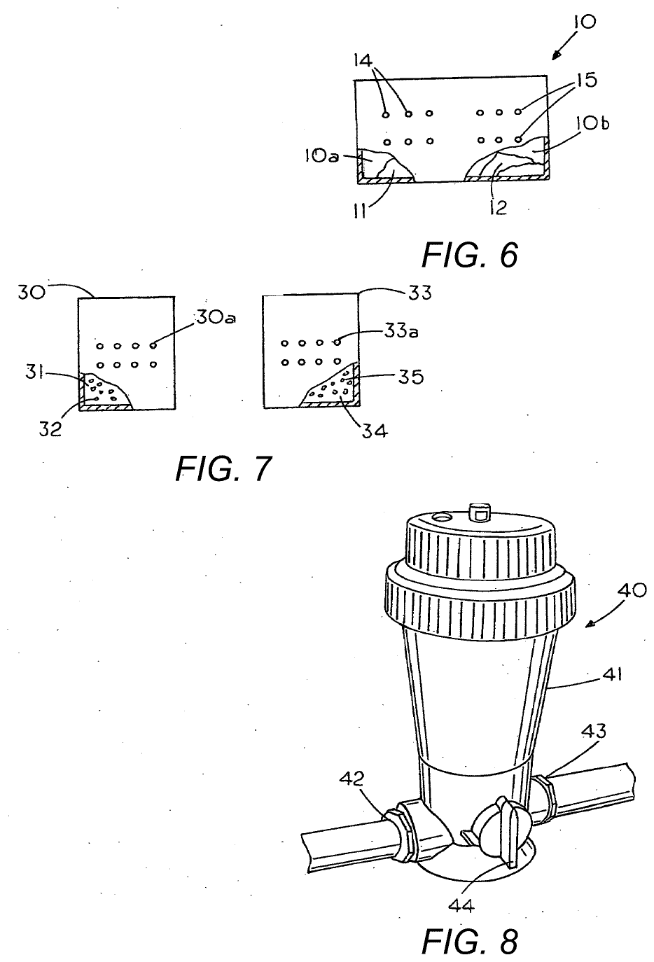

FIG. 8 shows an example of a dispersal valve 40 and FIG. 8A shows an example of a seasonal pool water treatment kit 80 that contains four canisters 51, 60, 65 and 70, which are suitable for dispensing materials when they are located in dispersal valve 40. In this example the seasonal pool water treatment kit 80 comprises a set of four nestable canisters 51, 60, 65 and 70 that can be periodically removed and replaced in dispersal valve 40 to provide season long outdoor pool maintenance for a pool, which is typically used in only the summer months. A box or other type of container 81 may be used to both store and deliver the seasonal pool water treatment kit to a consumer.

Referring to FIG. 8, reference numeral 40 general identifies a dispersal valve for normally and controllable dispersing multiple water treatment dispersants into a body of recreational water. Dispersal valve 40, which is shown in greater detail in King U.S. Pat. No. 6,190,547, includes a fluid inlet 42 on one side of a housing 41 and a fluid outlet 43 located on the opposite side of housing 41. A rotary plug 44 permits a user to control the velocity of the fluid mixing stream that is directed through the dispersal valve 40 and through the nestable canisters located in the dispersal valve 40.

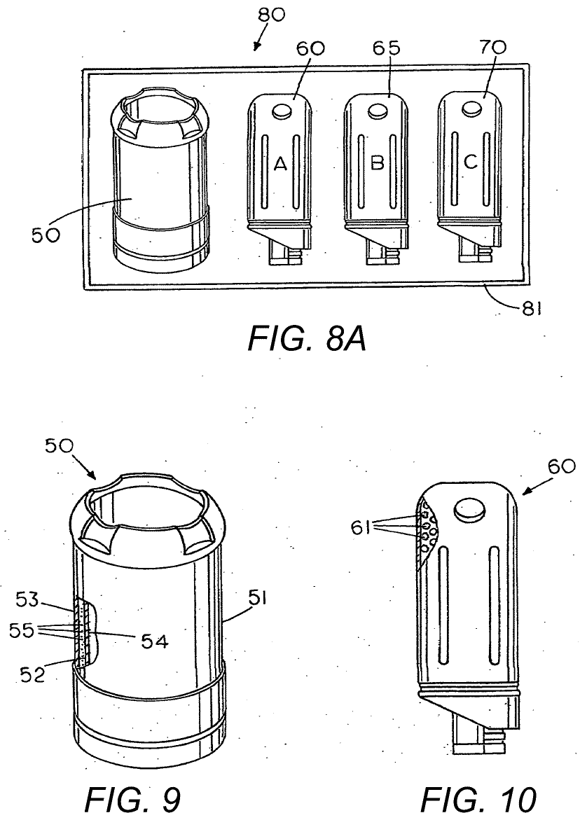

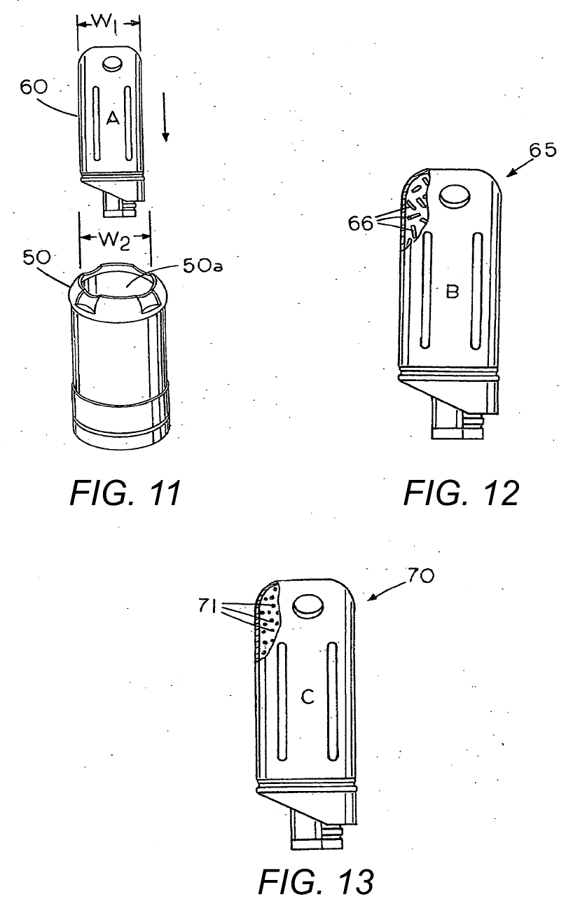

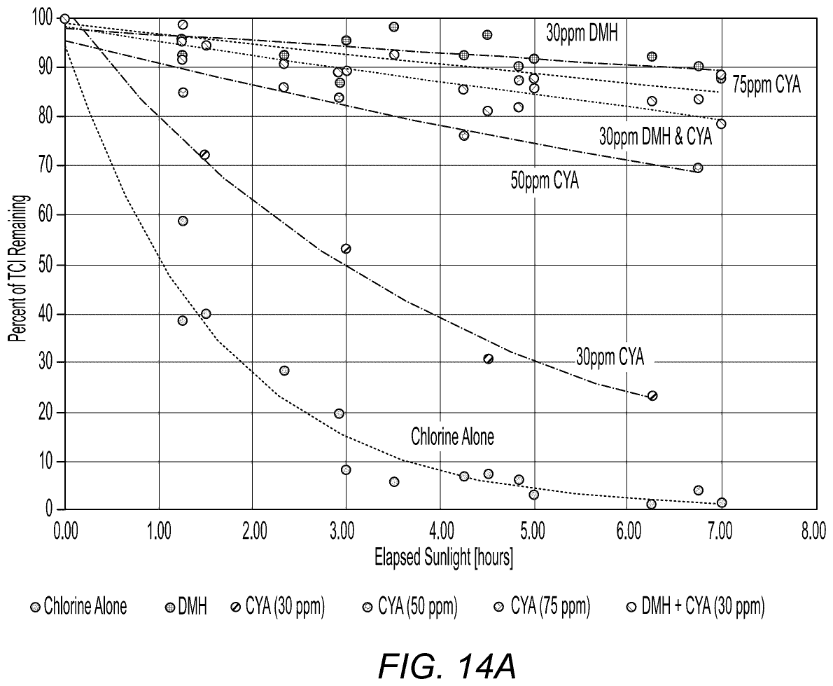

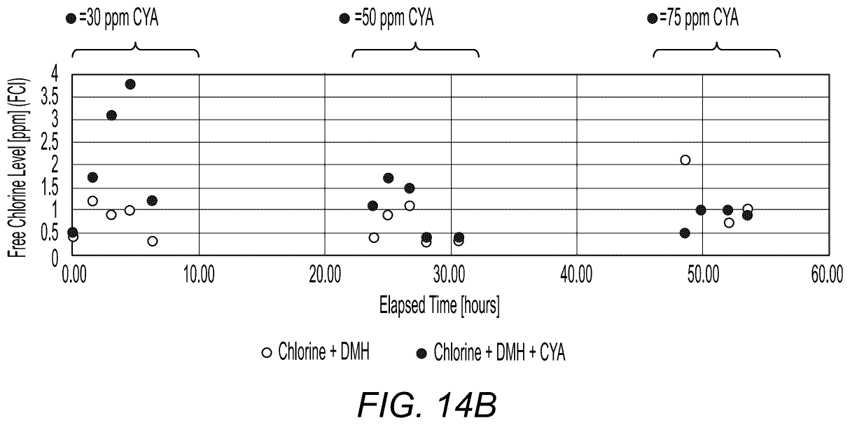

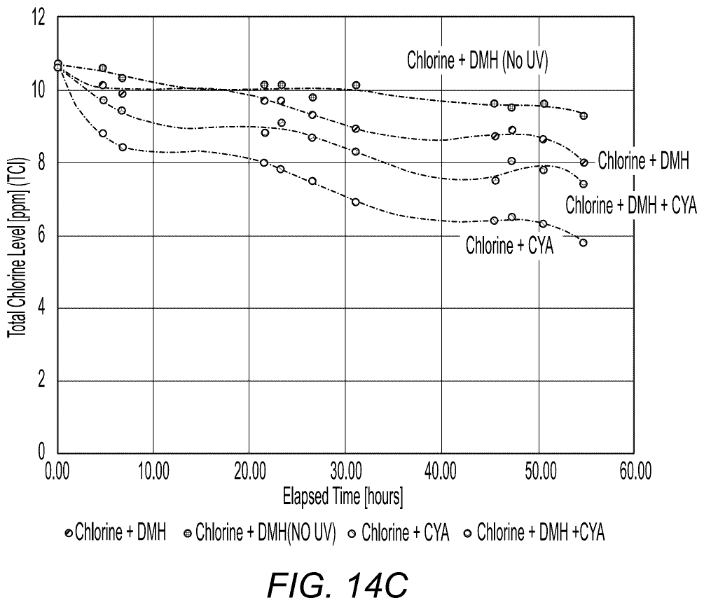

FIG. 9 shows a partial cutaway perspective view of an annular nestable canister 50 for insertion into dispersal valve 40. Nestable canister 50 is made from a rigid polymer plastic and normally stands in an upright position in a dispersal valve. In use the cylindrical nestable canister 60 can be nested within the annular nestable canister 50, as illustrated in FIG. 11. In the nested condition the two canisters 50 and 60 simultaneous deliver dispersant into the water flowing through the dispersal valve 40. Kit 80 also includes nestable canisters 65 and 70, which are shown in isolated and partial cut away views in FIG. 12 and FIG. 13. The three cylindrical nestable canisters 60, 65 and 70 (FIGS. 10, 12, and 13) are interchangeable with each other and provide dispersal valve 40 with multiple water treatment options for dispensing water treatment materials into a body of recreational water. The use of additional interchangeable nestable canisters 65 and 70 provide for a convenient seasonal system for on-the-go maintenance of an outdoor pool with a minimum of maintenance. In this example, annular canister 50 includes an outer cylindrical surface 51 that enables canister 50 to be axially inserted into an interior chamber of dispersal valve 40. In addition, nestable canister 50 has a central open region where a second nestable canister 60 can be functionally nested therein so that both canister 50 and canister 60 can simultaneously deliver dispersants to the water flowing through the dispersal valve. FIG. 9 shows nestable canister 50 also includes an annular chamber 54 defined by a cylindrical inner wall 52 and an outer cylindrical wall 53 with the annular chamber supporting typical water treatment materials such as minerals 55 therein. An example of minerals can be found in King U.S. Pat. No. 9,227,860, which is hereby incorporated by reference in its entirety.

FIG. 10 shows a partial cutaway side view of a cylindrical nestable canister 60. In the embodiment of FIG. 10, the cutaway view shows dispersants comprising a chlorinating agent 61 located within nestable canister 60. Examples of chlorinating agent 61 include chlorine tablets, granular or in powder form for killing bacteria although other types of chlorinating agents may be used. The operation of nestable canister 60 is similar to the operation of nestable canister 50 with the operation of the nestable canister shown and described in King U.S. Pat. No. 6,190,547, which is hereby incorporated by reference in its entirety.

FIGS. 10, 12 and 13 show examples seasonal dispersant canisters A, B and C that can be used to maintain a body of water such as a swimming pool during a typical outdoor season through a periodic rotation or replacement of canisters within the annular canister 50. In this example, the set of four canisters comprise an outer annular canister 50, which contains a first dispersant and a set of interchangeable canisters 60, 65 and 70, which can be individually fitted within annular canister 50. FIG. 8A shows the interchangeable canisters comprising a first cylindrical canister 60 (labeled A), which contains a second dispersant, a second cylindrical canister 65 (labeled B), which contains a second dispersant and a third cylindrical canister 70 (labeled C) which contains a third dispersant. Although four canisters are shown more or less canisters may be used depending on the type of seasonal water treatment needed.

FIG. 11 is an exploded view showing how nestable canister 60 can be axially inserted within a cylindrical chamber 50a in the annular nestable canister 50. Nestable canister 60 includes an outer dimension designated by W₁ and nestable canister 50 has an inside dimension designated by W₂ with W₂ greater than W so that canister 60 can be freely inserted within chamber 50a in the interior of canister 50. Nestable canister 65 and 70 are similarly dimensioned so that they can be inserted and removed from the annular nestable canister 50. Once in position, water directed through the bottom of the dispersal valve 40 comes into contact with the dispersants in the annular canister 50 and the cylindrical canister located within the annular canister 50.

FIG. 12 shows a partial cutaway side view of the second nestable canister 65. In this example, Canister B contains DMH with the DMH in an immediate dispensable state or a quickly dispensable state. By “immediate dispensable” or “quickly dispensable”, it is meant that the DMH contained within the dispenser can be dispensed into the swimming pool within 30 minutes or less and preferably within 15 minutes after coming into contact with the water.

Once the DMH is dispensed into the body of water canister B is removed from canister 50 and replaced with canister A from the set of seasonal canisters 50, 60 (canister A), 65 (canister B) and 70 (canister C). Canister A, which in this example contains a chlorinating agent 61 and the canister 50 which contains minerals 55 can now simultaneously dispense dispersant therein into the body of water to thereby seasonally maintain the body of water as the water flows through the dispersal valve containing the two canisters.

FIG. 13 shows a partial cutaway side view of the third nestable canister 70 (canister C) with a dispersant 71 therein. In this example canister C contains a dispersant 71 comprising an algaecide 71. To add the algaecide to the water the canister A in the nestable canister is removed and replaced with canister C containing the algaecide therein to thereby deliver the algaecide into the body of water. Once the algaecide is dispensed the canister C is removed and is replaced by Canister A, which contains the chlorinating agent. In this example the algaecide in canister C is delivered into the body of water through the canister in the dispersal valve, however, one may elect to deliver the algaecide directly into the body of water which eliminates the step of removing and replacing the canister A with canister C since the algaecide can be added independent of the dispersal valve canisters.

Preferably, a quickly dispensable algaecide 71 is used. Once the algaecide has been dispensed into the body of water the dispenser 71 is removed and the dispenser A with the chlorinating agent is placed in dispersal valve 40 to allow the chlorinating agent and the minerals to maintain the pool water. While in this example the algaecide has been introduced through an interchangeable canister in some instances the algaecide may be introduced into the pool independent of the dispersal valve system. In such an example the algaecide may be packaged in a non-interchangeable dispenser that can dispense the algaecide directly into the pool.

As described herein the start-up phase of the pool water treatment system begins with dispensing of the DMH, along with water treatment minerals 55, into the outdoor swimming pool body of water by loading nestable canister 50 and nestable canister 65 into dispersal valve 40 and activating the dispersal valve 40. The amount of DMH 66 in nestable canister 65 is determined by pool size such that the complete dispensing of the DMH 66 in nestable canister 65 brings the DMH level in the swimming pool to at least 20 ppm or at least 26 ppm.

Once the DMH 66 in nestable canister 65 is spent the pool maintenance phase of the pool water treatment system begins with the introduction of a chlorinating agent 61, along with water treatment minerals 55, into the swimming pool through the replacement of the spent nestable canister 65 with a fresh or new nestable canister 60. A feature of the present disclosure is that chlorinating agent 61, which is time dispensable, enables one to bring the total chlorine level in a swimming pool body of water to between 3.0 and 10 ppm with the concentration of DMH, which is about 26 ppm, maintaining a free chlorine level in the swimming pool body of water to a range 0.5 ppm to 1.0 ppm free chlorine. As described herein throughout the present disclosure, a further feature includes adding DMH to the body of water in an initial weight ratio of the total chlorine level in the body of water to the DMH in the body of water in a range of about 1:100 to about 4:5, and maintaining the free chlorine level in the body of water at a concentration of less than about 40% of the total chlorine level.

A pool booster phase, which may be used in some cases, begins with the addition of an algaecide. The pool booster phase is an optional on demand phase that generally occurs in response the presence of algae growth leading to a decrease of the free chlorine level in the swimming pool body of water to less than 0.5 ppm free chlorine. The pool booster phase may be addressed with the aforedescribed introduction of an immediate dispensable algaecide 71, along with water treatment minerals 55, into the swimming pool body of water through the replacement of nestable canister 60 (canister A) with nestable canister 70 (canister C containing the algaecide) to kill existing algae and control algae growth in the body of water while bringing the total chlorine level in the swimming pool body of water back to between 3.0 and 10 ppm. Once the algaecide in nestable canister 70 is dispensed into the pool the spent nestable canister 70 is replaced with the nestable canister 60 unless nestable canister 60 is also empty. In the event that canister 60 is also empty the spent nestable canister 70 is replaced with a fresh or new canister 60 that contains a fresh amount of chlorinate agent.

The pool booster phase starts with the introduction of an immediate dispensable algaecide 71, along with water treatment minerals 55, into the swimming pool body of water through the replacement of nestable canister 60 with nestable canister 70 to kill existing algae and control algae growth in the body of water while bringing the total chlorine level in the swimming pool body of water back to between 3.0 and 10 ppm. Once the algaecide is completely dispensed the spent nestable canister 70 is replaced with the used nestable canister 60 unless nestable canister 60 is also empty. In the event that canister 60 is also empty the spent nestable canister 70 is then replaced with a fresh or new canister 60.

As an alternative, instead of having the algaecide in nestable canister 70 the algaecide may be directly poured into the pool. In this example the canister with the chlorinating agent 60 need not be removed from the dispersal valve 40 during the delivery of the algaecide to the pool.

Thus, in a typically outdoor pool season the pool owner may first use Canister B in annular canister 50 followed by canister A, which is followed by canister C, which is again followed by canister B. Thus, the kit 80 provides a convenient way for maintaining an outdoor pool throughout the outdoor season without the need with the pool owner having to come into contact with the pool chemicals.

The disclosures described herein includes a number of methods of maintaining the free chlorine in a body of water for human immersion between 0.5 ppm and 1.0 ppm, or at a concentration less than about 40% of the total chlorine level, when subject to a bather load that consumes the free chlorine. In one method, a chlorinating agent may be added to overcome the initial sanitizing chlorine demand of the body of water while maintaining a temperature of the body of water between degrees 70° F. to 104° F. One adjusts the alkalinity of the body of water to between 80 ppm and 120 ppm by adding either sodium bicarbonate to raise the alkalinity or muriatic acid to lower the alkalinity while maintaining the pH in the body of water in the range of 7.2 to 7.8. Chlorine may be added to the body of water to bring the total chlorine level in the body of water in a range of about 1 ppm to about 20 ppm followed by adding DMH to the body of water to bring the level of free chlorine to about 1 ppm. In further aspects, the weight ratio of the total chlorine level in the body of water to the DMH in the body of water may be in a range of about 1:100 to about 4:5. At this point, one can subject the body of water to a bather load where the bather load consumes free chlorine and combined chlorine in the body of water without decreasing the free chlorine level to less than 0.5 ppm. The method may include adding chlorine to the body of water to bring the total chlorine level in the body of water in a range of about 1 ppm to about 20 ppm by adding chlorine from the group consisting of trichlor, calcium hypochlorite, sodium hypochlorite, lithium hypochlorite, chlorine gas, sodium dichloro-S-Triazinetrione, and sodium dichloroisocyanurate dihydrate to the body of water to bring the free chlorine level in the body of water to at least 1.0 ppm. The method may also include adding an additional chlorinating agent to the body of water to bring the total chlorine level in the body of water back to at least 3 ppm but less than 10 ppm after the free chlorine level of the body of water drops below 0.5 ppm. The method may also include adding a recharging dose of 5,5-dimethylhydantoin to bring the 5,5-dimethylhydantoin in the body of water up to at least 10 ppm.

A further method of maintaining the free chlorine in a body of water for human immersion between 0.5 ppm and 1.0 ppm when subject to a bather load that decreases the free chlorine by maintaining the pH in the body of water in the range of 7.2 to 7.8 through the addition of pH up or pH Down where pH up comprises sodium bicarbonate and pH down comprise sodium bisulfate. In this method, one maintains a temperature of the body of water between 65-105° F. and adjusts the alkalinity of the body of water to between 80 ppm and 120 ppm by either adding either sodium bicarbonate or a dry or liquid acid to the body of water. In this method one adds a chlorinating agent to the body of water to bring the total chlorine level in the body of water to at least 3 ppm and adds sufficient 5-5 dimethylhydantoin to the body of water to bring the level of free chlorine to about 1 ppm at this point one can subject the body of water to a bather load where the bather load consumes free chlorine in the body of water without decreasing the free chlorine to less than 0.5 ppm by adjusting a chlorine release rate from a dispenser until the free chlorine level remains above 1 ppm when subject to the bather load that consumes at least a portion of the free chlorine available in the body of water. The above method may include adding at least 3.5 ounces of DMH per gallon of water to bring the DMH concentration to at least 26 ppm.

A method of the disclosure may also include maintaining a safe free chlorine level in a body of water for recreational use where the free chlorine level at a harmful level measuring the free chlorine level in the body of water to determine if the free chlorine level in the body of water is above a safe level. The method may also include adding sufficient DMH to the body of water to bring the free chlorine down to a safe level by adding DMH to the body of water if the free chlorine level is above 3.5 ppm to reduce the free chlorine level to below 3.5 ppm.

A method of the disclosure may include a further method for extending the useful life of an outdoor pool wherein a chlorinating agent is continually or intermittently dispensed into the outdoor pool with the total chlorine level of the pool water ranging from 3-10 ppm by adding sufficient DMH to the pool to restore the DMH level to a level that maintains the free chlorine below 1.0 ppm. The above method may include periodically add additional DMH to the pool to bring the DMH level to at least 20 ppm or at least 26 ppm. The above method may include having a chlorinating agent dispensed into the pool selected from the group consisting of liquid bleach (NaClO), calcium hypochlorite (Ca(ClO)), trichloroisocyanauric acid (C₃Cl₃N₃O₃), chlorine gas, lithium hypochlorite, sodium dichloro-S-Triazinetrione, from an electrolytic cell that generates chlorine, or a combination thereof.

A method of the disclosure may include a method of maintaining the free chlorine in a body of water for human immersion between 0.5 ppm and 1.0 ppm, or at a concentration of less than about 40% of the total chlorine level when subject to a bather load and environmental conditions that decreases the free chlorine through maintaining a temperature of the body of water between degrees 70° F. to 104° F.; sanitizing the body of water with a chlorinating agent to render the body of water safe for human immersion; adjusting the alkalinity of the body of water to between 80 ppm and 120 ppm by adding either sodium bicarbonate to raise the alkalinity or muriatic acid to lower the alkalinity; maintaining the pH in the body of water in the range of 7.2 to 7.8; adding chlorine to the body of water to bring the total chlorine level in the body of water between 1-20 ppm; adding DMH to the body of water to bring the level of free chlorine to about 0.5 to 1.0 ppm, or at a concentration of less than about 40% of the total chlorine level; and subjecting the body of water to a bather load where the bather load consumes free chlorine and combined chlorine in the body of water without decreasing the free chlorine to less than 0.5 ppm level. In the above method, one may add chlorine to the body of water to bring the total chlorine level in the body of water in a range of about 1 ppm to about 20 ppm by adding chlorine to the body of water to bring the total chlorine level in the body of water to a range of about 3 ppm and 10 ppm, or a weight ratio of the total chlorine level in the body of water to the DMH in the body of water in a range of about 1:100 to about 4:5. In the above method, an additional chlorinating agent may be added to the body of water to bring the total chlorine level in the body of water back to between 3 and 10 ppm, or the weight ratio of the total chlorine level in the body of water to the DMH in the body of water in a range of about 1:100 to about 4:5, after the free chlorine level of the body of water drops below 0.5 ppm. In the above method one may add a recharging dose of 5,5-dimethylhydantoin to bring the 5,5-dimethylhydantoin in the body of water up to at least 20 ppm. In the above method, one may maintain a concentration of the 5,5-dimethylhydantoin in the body of water above 20 ppm. The above method may include adding an algaecide to the body of water at the sign of algae growth. Alternately, the method may include adding an algaecide to the body of water and an additional chlorinating agent to the body of water to bring the total chlorine level in the body of water back to a range of about 3 ppm and about 10 ppm, or a weight ratio of the total chlorine level in the body of water to the DMH in the body of water in a range of about 1:100 to about 4:5, at the sign of algae growth.

A method of the disclosure may include maintaining the free chlorine in a body of water for human immersion in a range of about 0.5 ppm and about 1 ppm, or at a concentration of less than about 40% of the total chlorine level, when subject to a bather load and environmental conditions that decreases the free chlorine comprises maintaining a temperature of the body of water between degrees 70° F. to 104° F. by sanitizing the body of water with a chlorinating agent to render the body of water safe for human immersion; adjusting the alkalinity of the body of water to between 80 ppm and 120 ppm by adding either sodium bicarbonate to raise the alkalinity or muriatic acid to lower the alkalinity; maintaining the pH in the body of water in the range of 7.2 to 7.8; loading a first dispensing cartridge containing an immediate dispensable DMH therein into an inline dispenser of the body of water to bring a DMH level in the body of water to at least 20 ppm or at least 26 ppm; loading a second dispensing cartridge containing a time dispensable chlorinating agent therein into the inline dispenser of the body of water to bring the total chlorine level in a body of water containing at least 20 ppm or at least 26 ppm DMH to a range of about 3 ppm and about 10 ppm total chlorine, or a weight ratio of the total chlorine level in the body of water to the DMH in the body of water in a range of about 1:100 to about 4:5, with the concentration of DMH maintaining a free chlorine level in the swimming pool body of water to a range of about 0.5 ppm to about 1 ppm free chlorine, or at a concentration of less than about 40% of the total chlorine level; and then subjecting the body of water to a bather load where the bather load consumes free chlorine and combined chlorine in the body of water without decreasing the free chlorine to less than 0.5 ppm level.

In some embodiments, the disclosed methods may include the step of loading a third dispensing cartridge containing a time dispensable combination chlorinating agent and algaecide therein into the inline dispenser of the body of water in response to a decrease of the free chlorine level in the body of water to less than 0.5 ppm free chlorine to kill existing algae and control algae growth in the body of water while bringing the total chlorine level in the body of water back to a range of about 3 ppm and about 10 ppm, or a weight ratio of the total chlorine level in the body of water to the DMH in the body of water in a range of about 1:100 to about 4:5. The above method may also include loading a third dispensing cartridge containing an immediate dispensable algaecide therein into the inline dispenser of the body of water at the sign of algae growth water to kill existing algae and control algae growth in the body of water.

In embodiments, the disclosed methods may include the loading of a third dispensing cartridge containing a time dispensable combination chlorinating agent and algaecide therein into the inline dispenser of the body of water at the sign of algae growth to kill existing algae and control algae growth in the body of water while bringing the total chlorine level in the body of water back to between 3.0 and 10 ppm. The above may include loading a third dispensing cartridge containing an immediate dispensable DMH therein into the inline dispenser of the body of water to bring the DMH level in the body of water up to at least 20 ppm.

A method of the disclosure may include a method of treating a swimming pool body of water to maintain a free chlorine in the body of water for human immersion between 0.5 ppm and 1.0 ppm when subject to a bather load and environmental conditions that decreases the free chlorine by maintaining a temperature of the body of water between degrees 70° F. to 104° F.; sanitizing the body of water with a chlorinating agent to render the body of water safe for human immersion; adjusting the alkalinity of the body of water to between 80 ppm and 120 ppm by adding either sodium bicarbonate to raise the alkalinity or muriatic acid to lower the alkalinity; maintaining the pH in the body of water in the range of 7.2 to 7.8; nestably connecting a first dispensing nestable canister containing an immediate dispensable DMH therein into a chamber of an annular dispensing nestable canister containing water treatment minerals therein loading the first dispensing nestable canister with the annular dispensing nestable canister into an inline dispersal valve of the body of water to bring a DMH level in the body of water to at least 20 ppm or at least 26 ppm; replacing said first dispensing nestable canister with a second dispensing nestable canister containing a time dispensable chlorinating agent therein to bring the total chlorine level in a body of water containing at least 20 ppm or at least 26 ppm DMH to between about 3 ppm and about 10 ppm total chlorine with the concentration of DMH maintaining a free chlorine level in the swimming pool body of water to a range 0.5 ppm to 1 ppm free chlorine; and then subjecting the body of water to a bather load where the bather load consumes free chlorine and combined chlorine in the body of water without decreasing the free chlorine to less than 0.5 ppm level. The above method may include replacing the second dispensing nestable canister with a third dispensing nestable canister containing a combination time dispensable chlorinating agent and algaecide therein in response to a decrease of the free chlorine level in the body of water to less than 0.5 ppm free chlorine to kill existing algae and control algae growth in the body of water while bringing the total chlorine level in the body of water back to between 3.0 and 10 ppm. The above method may include replacing the second dispensing nestable canister with a third dispensing nestable canister containing an immediate dispensable algaecide therein at the sign of algae growth water to kill existing algae and control algae growth in the body of water. The above method may include the replacing the second dispensing nestable canister with a third dispensing nestable canister containing a combination time dispensable chlorinating agent and algaecide therein at the sign of algae growth to kill existing algae and control algae growth in the body of water while bringing the total chlorine level in the body of water back to between 3.0 and 10 ppm. The above method may replace the second dispensing nestable canister with a fresh first dispensing nestable canister to bring the DMH level in the body of water up to at least 20 ppm.

The disclosures described herein may take various forms including, prepackaged free chlorine maintainer for emptying into a body of water to maintain a free chlorine level in the body of water between 0.5 ppm and 1.0 ppm when the body of water is subject to a bather load with the free chlorine maintainer consisting of a chlorinating agent and DMH in solid form where a weight ratio of the DMH to the chlorinating agent in the body of water is at least 0.5 with the DMH and the chlorine maintainer either added separately or at the same time. In this example the chlorine maintainer may be a one-shot prepackaged free chlorine maintainer that includes a water dissolvable polyvinyl alcohol film located around the DMH.

The disclosure may take the form of a spa product for maintaining the free chlorine level between about 0.5 ppm and 1 ppm in a body of water subject to a bather load with the spa product comprising: a first dispenser containing a chlorinating agent selected from the group consisting of trichloroisocyanauric acid (trichlor), potassium dichloroisocyanurate, and sodium dichlorcyanurate (dichlor) with the first dispenser having a port for water access to the chlorinating agent therein when the first dispenser is placed in the body of water; and a second dispenser containing dimethylhydantoin with the second dispenser having a port for water access for release of the dimethylhydantoin into the body of water.

In examples, the spa product may have a weight ratio of DMH in the second dispenser to the chlorinating agent in the first dispenser ranging from 0.31 to 6.3 or a weight ratio of DMH in the second dispenser to the chlorinating agent in the first dispenser that varies as a function of time when the chlorinating agent is sodium dichloroisocyanurate dihydrate.

The disclosure may take the form of a one-shot prepackaged free chlorine maintainer for emptying into a body of water to maintain a free chlorine level in the body of water between 0.5 ppm and 1.0 ppm, or to maintain the free chlorine level in the body of water at a concentration of less than about 40% of the total chlorine level, when the body of water is subject to a bather load with the free chlorine maintainer consisting of a chlorinating agent in solid form and DMH in solid form where a weight ratio of the DMH to the chlorinating agent is at least 0.5 and the chlorinating agent and the DMH are either added separately or at the same time to the body of water. In some aspects, the initial weight ratio of the total chlorine level in the body of water to the DMH in the body of water may instead be in a range of about 1:100 to about 4:5. As an example, the one-shot prepackaged free chlorine maintainer containing 5,5-dimethylhydantoin is sufficient to raise the 5,5-dimethylhydantoin level to 10 to 20 ppm in a body of water where a total chlorine concentration is at least 3 ppm with the chlorinating agent comprising sodium dichloroisocyanurate or sodium trichloroisocyanurate.

The disclosure may take the form of a free chlorine maintainer for a body of water wherein a concentration of the free chlorine maintainer consists of a chlorinating agent and 5,5-dimethylhydantoin with the body of water having at least 5 grams of the free chlorine maintainer per gallon of water where the chlorinating agent is selected from the group consisting of trichloroisocyanauric acid, potassium dichloroisocyanurate, sodium dichloroisocyanurate as anhydrous or dihydrate form, calcium hypochlorite, lithium hypochlorite and sodium hypochlorite. For example, the prepackaged free chlorine maintainer for a body of water ranging between 100 to 600 gallons wherein the weight of dimethylhydantoin added to the body of water is at least 17 grams but less than 115 grams.

The disclosure may take the form of a pool product for maintaining a free chlorine level in a range of about 0.5 ppm to about 1 ppm, or maintaining the free chlorine level in the body of water at a concentration of less than about 40% of the total chlorine level, in a pool wherein the pool is subject to a periodic bather load and the pH of the pool is maintained between 7.2 and 7.8 comprising: a first dispenser having a compartment containing a chlorinating agent for a placing in an outdoor pool; and a second dispenser having a compartment containing 5,5-dimethylhydantoin wherein a release of the chlorinating agent from the first dispenser increases the total chlorine to at least 3 ppm and a release of the 5,5-dimethylhydantoin from the second dispenser in the pool lowers the free chlorine level between 0.5 ppm and 1 ppm. In this example, the first dispenser containing the chlorinating agent is placed in the body of water before the second dispenser containing the dimethylhydantoin is placed in the body of water.

The disclosure may take the form of a spa for absorbing a bather load without having to increase a free chlorine level in the body of water through addition of an additional chlorinating agent wherein the body of water: is between 65-105° F. with a pH in the range of 7.2 to 7.8; an alkalinity in the range of 80 ppm to 120 ppm and a measured level of total chlorine comprising a dimethylhydantoin associated chlorine of at least 3 ppm and a measured level of free chlorine in a range of 0.5 ppm and 1.0 ppm after the body of water has been subjected to a combination of a chlorinating agent and dimethylhydantoin but before the body of water is subject to the bather load wherein the bather load absorbs the free chlorine in the body of water as the dimethylhydantoin converts the dimethylhydantoin associated chlorine to the free chlorine to thereby maintain the free chlorine in the range of 0.5 ppm to 1 ppm as long as the bather load chlorine demand does not exceed the dimethylhydantoin associated chlorine.

The disclosure may take the form of a free chlorine maintained system for absorbing a bather load without having to increase a free chlorine level in the body of water through addition of an additional chlorinating agent where the body of water has: a temperature that ranges from 60° F. to 120° F., a pH that ranges from 7.2 to 7.8; an alkalinity that ranges from 80 ppm to 120 ppm; a measured level of total chlorine comprising a dimethylhydantoin associated chlorine that is at least 3 ppm; and a free chlorine maintainer consisting of a chlorinating agent and dimethylhydantoin where a measured level of free chlorine ranges from about 0.5 ppm to about 1.0 ppm both before and after the body of water is subjected to the bather load and without addition of additional chlorine to the body of water. In this example the concentration of the dimethylhydantoin in the body of water ranges from 20 ppm to 200 ppm. In further examples, the concentration of total chlorine in the body of water is at least 3 ppm.

The disclosure may take the form of a set of dispensing cartridges for placing in a back-to-back condition in an inline dispenser comprising: a first dispensing cartridge having a bottom inlet and a bottom outlet and containing a time dispensable chlorinating agent therein; and a second dispensing cartridge having a bottom inlet and a bottom outlet and an immediate dispensable DMH therein in sufficient amount to increase the concentration of DMH to a level that reduces a free chlorine level to a range of about 0.5 ppm to about 1.0 ppm, or to maintain the free chlorine level in the body of water at a concentration of less than about 40% of the total chlorine level. In examples, the set of dispensing cartridges may include a further dispensing cartridge containing an algaecide wherein the algaecide is dispensed into the body of water in response to a decrease of the free chlorine level to less than 0.5 ppm. In further aspects, the set of dispensing cartridges contain sufficient chlorine to bring a total chlorine in the body of water in the range of about 3 ppm to about 10 ppm, or a weight ratio of the total chlorine level in the body of water to the DMH in the body of water in a range of about 1:100 to about 4:5.

The disclosure may take the form of a prepackaged free chlorine maintainer for use in a body of water that has been sanitized with a chlorinating agent to render the body of water safe for human immersion, the free chlorine maintainer including: a source of chlorine in solid form, the source of chlorine fully dissolvable in the body of water to bring the total chlorine level in the body of water to between 3 and 10 ppm; and a source of DMH in solid form, the source of DMH fully dissolvable in the body of water to bring the level of DMH in the body of water above 10 ppm while maintaining a level of free chlorine in the body of water between about 0.5 to 1.0 ppm.

In this example the disclosure may include a source of an algaecide in solid form, dissolvable in the body of water to kill existing algae and control algae growth in the body of water. In this example the prepackaged free chlorine maintainer may include a water dissolvable polyvinyl alcohol film housing encompassing the free chlorine maintainer. In this example the body of water may comprises an outdoor swimming pool.

In this example the prepackaged free chlorine maintainer is used in body of waters that ranges between 10,000 to 15,000 gallons, between 4,000 to 6,000 gallons or between 100 to 600 gallons. In this example the body of water comprises a spa or hot tub.

The disclosure may take the form of a prepackaged free chlorine maintainer for use in a body of water that has been sanitized with a chlorinating agent to render the body of water safe for human immersion, the free chlorine maintainer including a recharging dose of chlorine in solid form, the recharging dose of chlorine dissolvable in the body of water to bring the total chlorine level in the body of water to between 3 and 10 ppm; and a recharging dose of DMH in solid form, the recharging dose of DMH dissolvable in the body of water to bring the level of DMH in the body of water above 10 ppm.

The disclosure may take the form an outdoor swimming pool free chlorine maintaining dispenser for use in an outdoor swimming pool body of water that has been sanitized with a chlorinating agent to render the body of water safe for human immersion and subject to a periodic bather load and environmental conditions, the free chlorine maintaining dispenser including: a first housing having a water accessible compartment containing a chlorinating agent releasable into the body of water to maintain the total chlorine level in the body of water above 4 ppm; a second housing having a water accessible compartment containing a source of DMH dissolvable in the body of water to maintain the level of DMH in the body of water above 10 ppm while maintaining a level of free chlorine in the body of water between about 0.5 to 1.0 ppm. As an example, the free chlorine maintaining dispenser may include a third housing having a water accessible compartment containing a source of an algaecide in solid form, the source of algaecide dissolvable in the body of water to kill existing algae and control algae growth in the body of water. As a further example, the third housing may comprise a detachable third housing.

The disclosure may take the form a prepackaged free chlorine maintainer for use in a body of water that has been sanitized with a chlorinating agent to render the body of water safe for use as potable water, the free chlorine maintainer including: a source of chlorine in solid form, the source of chlorine fully dissolvable in the body of water to bring the total chlorine level in the body of water to between 3 and 10 ppm; and a source of DMH in solid form, the source of DMH fully dissolvable in the body of water to bring the level of DMH in the body of water above 10 ppm while maintaining a level of free chlorine between about 0.5 to 1 ppm.

The disclosure may take the form of a swimming pool free chlorine maintaining kit for use in an inline dispenser of a swimming pool body of water that has been sanitized with a chlorinating agent to render the body of water safe for human immersion and subject to a periodic bather load and environmental conditions, the swimming pool free chlorine maintaining kit including: a first dispensing cartridge having a bottom inlet and a bottom outlet and an immediate dispensable DMH therein in sufficient amount to bring a DMH level in the swimming pool body of water to at least 20 ppm or at least 26 ppm and a second dispensing cartridge having a bottom inlet and a bottom outlet and containing a time dispensable chlorinating agent therein to bring the total chlorine level in a swimming pool body of water containing at least 20 ppm or at least 26 ppm DMH to a range of about 3 and about 10 ppm total chlorine, or an initial weight ratio of the total chlorine level in the body of water to the DMH in the body of water in a range of about 1:100 to about 4:5, with the concentration of DMH maintaining a free chlorine level in the swimming pool body of water to a range of about 0.5 ppm to about 1.0 ppm free chlorine, or at a concentration of less than about 40% of the total chlorine level. In this example, the swimming pool free chlorine maintaining kit may include a third dispensing cartridge having a bottom inlet and a bottom outlet and containing a time dispensable combination chlorinating agent and algaecide, the combination chlorinating agent and algaecide dispensable into the swimming pool body of water in response to a decrease of the free chlorine level in the swimming pool body of water to less than about 0.5 ppm free chlorine to kill existing algae and control algae growth in the body of water while bringing the total chlorine level in the swimming pool body of water back to between 3 and 10 ppm, or a weight ratio of the total chlorine level in the body of water to the DMH in the body of water in a range of about 1:100 to about 4:5. Also, as an example, the swimming pool free chlorine maintaining kit may include a third dispensing cartridge having a bottom inlet and a bottom outlet and containing an immediate dispensable algaecide therein, the algaecide dispensable into the swimming pool body of water at the sign of algae growth to kill existing algae and control algae growth in swimming pool body of water.

As a further example, the swimming pool free chlorine maintaining kit may include a third dispensing cartridge having a bottom inlet and a bottom outlet and containing a time dispensable combination chlorinating agent and algaecide, the combination chlorinating agent and algaecide dispensable into the swimming pool body of water at the sign of algae growth to kill existing algae and control algae growth in the swimming pool body of water while bringing the total chlorine level in the swimming pool body of water back to a range of about 3 ppm and about 10 ppm, or a weight ratio of the total chlorine level in the body of water to the DMH in the body of water in a range of about 1:100 to about 4:5.

The disclosure may take the form of swimming pool water treatment system for use in an inline dispenser of a swimming pool body of water that has been sanitized with a chlorinating agent to render the body of water safe for human immersion and subject to a periodic bather load and environmental conditions, the swimming pool water treatment system including: a dispersal valve for directing water therethrough, the dispersal valve having an internal chamber; a first dispensing nestable canister having a bottom inlet and a bottom outlet and an immediate dispensable DMH therein in sufficient amount to bring a DMH level in the swimming pool body of water to at least 20 ppm or at least 26 ppm; a second dispensing nestable canister having a bottom inlet and a bottom outlet and containing a time dispensable chlorinating agent therein to bring the total chlorine level in a swimming pool body of water containing at least 20 ppm or at least 26 ppm DMH in a range of about 3 ppm and about 10 ppm total chlorine, or an initial weight ratio of the total chlorine level in the body of water to the DMH in the body of water in a range of about 1:100 to about 4:5, with the concentration of DMH maintaining a free chlorine level in the swimming pool body of water to a range of about 0.5 ppm to about 1 ppm free chlorine, or at a concentration of less than about 40% of the total chlorine level; and an annular dispensing nestable canister having a bottom inlet and a bottom outlet and containing water treatment minerals therein, the annular dispensing nestable canister having a chamber for nestably supporting the first dispensing nestable canister or the second dispensing nestable canister therein with the annular dispensing nestable canister and the dispensing nestable canister supported in the internal chamber of the dispersal valve to provide the dispersal valve with multiple water treatment dispersants for dispensing into a swimming pool body of water. As an example the swimming pool water treatment system may include a third dispensing nestable canister nestably supportable within the chamber of the annular dispensing nestable canister and having a bottom inlet and a bottom outlet and containing a combination time dispensable chlorinating agent and algaecide, the combination chlorinating agent and algaecide dispensable into the swimming pool body of water in response to a decrease of the free chlorine level in the swimming pool body of water to less than 0.5 ppm free chlorine to kill existing algae and control algae growth in the body of water while bringing the total chlorine level in the swimming pool body of water back to a range of about 3 ppm and about 10 ppm, or a weight ratio of the total chlorine level in the body of water to the DMH in the body of water in a range of about 1:100 to about 4:5.

As a further example, the swimming pool water treatment system may include a third dispensing nestable canister nestably supportable within the chamber of the annular dispensing nestable canister and having a bottom inlet and a bottom outlet and containing an immediate dispensable algaecide therein, the algaecide dispensable into the swimming pool body of water at the sign of algae growth to kill existing algae and control algae growth in swimming pool body of water. A further example of the swimming pool water treatment system may include a third dispensing nestable canister nestably supportable within the chamber of the annular dispensing nestable canister and having a bottom inlet and a bottom outlet and containing a combination time dispensable chlorinating agent and algaecide, the combination chlorinating agent and algaecide dispensable into the swimming pool body of water at the sign of algae growth to kill existing algae and control algae growth in the swimming pool body of water while bringing the total chlorine level in the swimming pool body of water back to a range of about 3 ppm and about 10 ppm, or a weight ratio of the total chlorine level in the body of water to the DMH in the body of water in a range of about 1:100 to about 4:5.

In further embodiments, the disclosure provided herein includes a method of accelerating the decomposition of DMH in a body of water. In some implementations, it may be beneficial to accelerate the decomposition of DMH, such as, for periods of time where a biocidal treatment will need to be applied to the body of water. In some aspects, the biocidal treatment shocks the body of water by adding a higher than usual dose of oxidizer chemicals to treat the water. Shocking the body of water can reduce bacteria and impurities within the body of water. In some aspects, due to the ability of DMH to maintain levels of free chlorine as disclosed herein, the presence of DMH can hinder the effectiveness of compositions used to shock a body of water. In embodiments where it may be beneficial to accelerate the decomposition of DMH in the body of water, the method includes adding a chlorinating agent to the body of water containing DMH thereby contributing to a total chlorine level in the body of water, such that a weight ratio of the total chlorine level in the body of water to the DMH is greater than about 1:2. In some aspects, there is no upper limit range for the weight ratio of the total chlorine level to DMH provided that the weight ratio is greater than about 1:2, however, non-limiting examples may consider a weight ratio of total chlorine level in the body of water to DMH in a range of greater than about 1:2 to about 10:1. However, higher weight ratios may be utilized effectively as would be understood by those skilled in the art. The chlorinating agent may be any chlorinating agent as described herein, including, but not limited to chlorinating agents comprising or resulting from liquid bleach, calcium hypochlorite, trichloroisocyanuric acid, an electrolytic cell that generates chlorine, chlorine gas, lithium hypochlorite, sodium dichloro-S-Triazinetrione, or a combination thereof.

In some aspects, adding the chlorinating agent to the body of water increases the free chlorine level in the body of water to a concentration of greater than about 25% of the total chlorine level. At levels of free chlorine greater than about 25% of the total chlorine level, the decomposition rate of DMH will accelerate, making the body of water suitable to accept further biocidal treatment. In some aspects, the biocidal treatment may include any treatment that shocks the body of water. The biocidal treatment, or “shock”, may be any treatment known to those skilled in the art. As further described herein, CYA may be further added to the body of water or may be further present in the body of water with the DMH.

All publications and patent applications in this specification are indicative of the level of ordinary skill in the art to which this disclosure pertains. All publications and patent applications are herein incorporated by reference to the same extent as if each individual publication or patent application was specifically and individually indicated as incorporated by reference.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

To verify the benefit of the use of DMH, various tests were conducted in a seasonal outdoor pool to determine the response to environmental loads as well as to periodic bather loads. Generally, in the initial step, the water conditions of the outdoor pool was set up as follows:
1. Initially set the water temperature of the pool at about 85° F. although the water temperature would fluctuate due to outside weather conditions.
2. Adjusted the calcium hardness of the pool water to 200 ppm.
3. Adjusted the alkalinity of the pool water to be within the range of 80-120 ppm.
4. Adjusted the pH of the pool water to be within the range of 7.2 to 7.8.

The above base conditions are typical of pool set up conditions and created through the use of known pool products in order to create a body of water that was suitable and comfortable for use by an individual or a group of individuals. In some instances, the base conditions may be changed for the convenience of the pool owner without departing from the spirit and scope of the disclosure as long as the total chlorine level can be reduced to a free chlorine level of about 1 ppm or less through the addition of DMH to the body of water.

### Example 1

### Chlorine without the Use of DMH

A first test (chlorine without DMH) was conducted to show the free chlorine level in a body of water, which was subjected to a bather load. The container for the body of recreational water was a 400-gallon Hot Springs® Vanguard® brand spa. The procedure for preparing test water was as follows:
1) Fill container with fresh tap water, with softener partially bypassed to give approximately 200 parts per million of calcium hardness. Measure and record calcium hardness.
2) Adjust temperature setting to 85 degrees Fahrenheit.
3) Add sodium bisulfate “pH Down” to adjust alkalinity into the 80-120 ppm range.
4) Add sodium dichloroisocyanurate dihydrate “dichlor” to overcome the initial chlorine demand of the water.
5) After 1 day, adjust pH into the 7.2 to 7.8 range by running the jets.
6) Measure & record temperature.

For the test with dichlor the procedure was as follows:
1) Adjust free chlorine residual into the 0.5 to 1.0 ppm range.
2) Measure and record chlorine residuals, pH, and total alkalinity.
3) Have 2-4 bathers sit in the spa for 15-20 minutes. Record # of bathers and time.
4) Allow 30 minutes to pass, then measure and record chlorine residuals.
5) Allow 1 more hour to pass, then measure and record chlorine residuals.

The container was filled with fresh tap water, with softener partially bypassed and tested using a Taylor® kit K-2006 Calcium Hardness drop test which measured water hardness of approximately 200 parts per million of calcium hardness.

The total Alkalinity of the recreational water was measured using a Taylor® kit K-2006 Alkalinity drop test. To adjust the total alkalinity levels of the water to the 80-120 ppm range 95% Sodium Bisulfate (pH Down) was added to the water. The 95% Sodium Bisulfate, which was added to the body of recreational water, was obtained from Great Lakes Biochemicals®. To add chlorine to the body of recreational water in the containers 99% Sodium Dichloroisocyanurate dihydrate (dichlor) was added to the water. The 99% Sodium Dichloroisocyanurate dihydrate was obtained from Great Lakes Biochemicals®, and applied to the body of water to overcome the initial sanitizing chlorine demand of the water in the container. As used herein the term Dichlor refers to Dichloroisocyanurate dihydrate and the term DMH refers to 5-5 dimethylhydantoin while the reference in ppm is to parts per million by weight.

The water temperature in the container was measured using a Thermoworks® Superfast Digital Thermometer and the water in the container was maintained at about 85° F.

The water in the containers was allowed to stabilize for a day after which the pH levels of the water in the container was measured using an Oakton® EcoTestr pH 2 meter. To adjust the pH level in the body of water the pH jets in each of the containers were run until the pH level in each of the containers was within the range of 7.2 to 7.8.

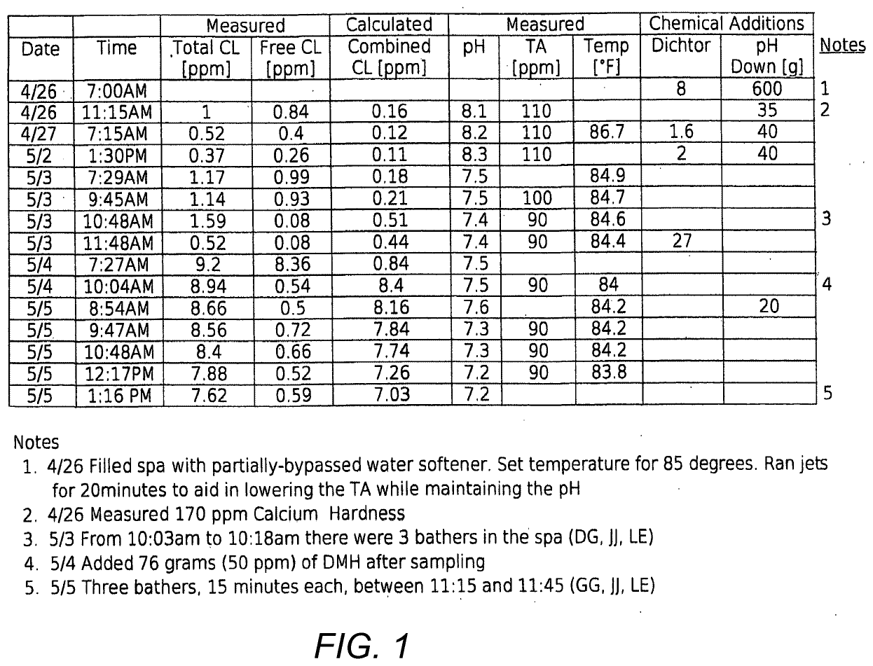

FIG. 1 shows a table of the results of the test (with and without DMH) where the free chlorine, the total chlorine, the pH, the total alkalinity and the temperature were measured after 400-gallon Hot Springs® Vanguard® brand spa and pH down had been added to the spa water in a 400-gallon Hot Springs® Vanguard® brand spa.

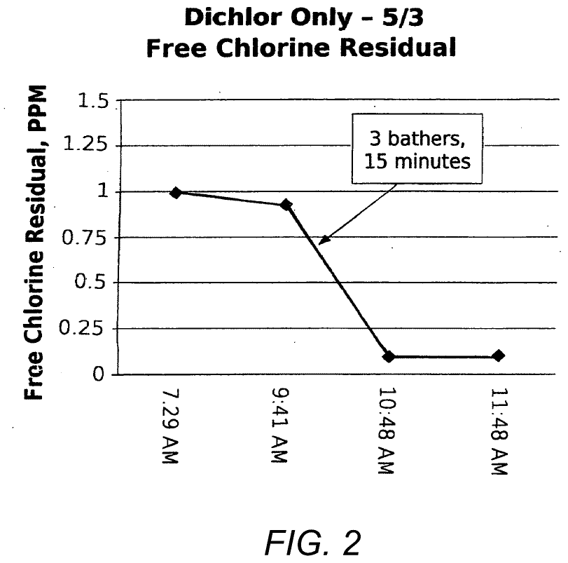

FIG. 2 shows a graph of the free chlorine as a function of time with the 400-gallon Hot Springs® Vanguard® brand spa (without DMH) which contains Dichlor as the spa water is subjected to a bather load. As can be seen the level of free chlorine declines from 1 ppm to about 0.1 ppm in response to the bather load.

FIG. 2A shows a graph of the free chlorine as a function of time with the 400-gallon Hot Springs® Vanguard® brand spa which contains Dichlor and DMH as the spa water is subjected to a bather load. As can be seen the level of free chlorine remains in a range of about 0.7 ppm to 0.6 ppm in response to the bather load.

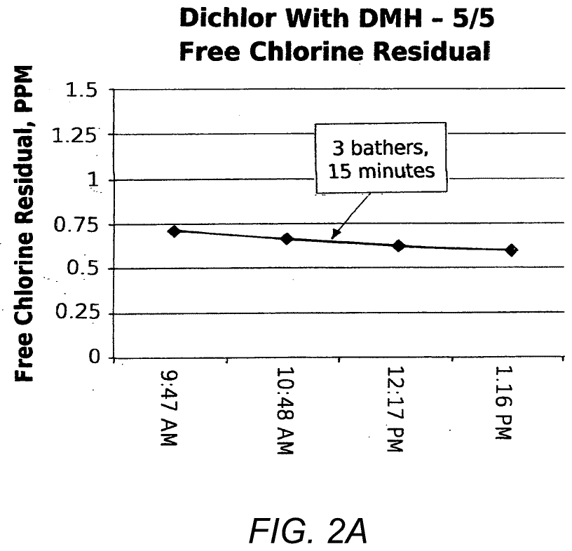

FIG. 3 shows a graph of the free chlorine and the total chlorine as a function of time with the 400-gallon Hot Springs® Vanguard® brand spa which contains Dichlor and no DMH as the spa water is subject to a bather load that creates an immediate need for free chlorine to neutralize the effects of bathers in the pool. As can be seen the level of both the free chlorine and the total chlorine declines with the free chlorine declining to 0 ppm while the total chlorine declines from 1.0 ppm to about 0.5 ppm in response to the bather load. The reference to ppm used herein is in reference to ppm by weight.

On the contrary, FIG. 3A shows a graph of the free chlorine and the total chlorine as a function of time with the 400-gallon Hot Springs® Vanguard® brand spa where the spa water contained chlorine introduced through the addition of Dichlor and DMH as the spa water was subject to a bather load. In the example described, the Dichlor was added to the body of water before the DMH was added. The results demonstrated that the level of the free chlorine remained between 1.0 ppm and 0.5 ppm when the spa water was subject to the bather load while the total chlorine declined from about 8.5 to about 7.5 as the spa water was subject to the bather load.

With the above methods one can add chlorine to the body of water to bring the total chlorine level in the body of water in a range of about 1 ppm to about 20 ppm. In this example, it has been found that if one adds DMH to the body of water, one can bring the level of free chlorine to about 1 ppm as the addition of DMH has been found to lower the measurable free chlorine until a stable or equilibrium state of about 1.0 ppm is obtained.

### Example 2

### Chlorine with Use of DMH

A second test (chlorine with DMH) was conducted to show the response of the free chlorine level in a body of water, which was subjected to a similar bather load when both chlorine and DMH were present in the body of water. In this example a 300-gallon Marquis Destiny spa was filled with tap water with pH Down® added to the body of water to adjust the pH of the water. The use of a 300-gallon spa for testing was for convenience since the use of both dimethylhydantoin (DMH) and Dichlor are scalable features applied to large bodies of water such as pools as well as smaller bodies of water such as hot tubs, spas, or the like. In this example both dimethylhydantoin (DMH) and Dichlor in solid form were added directly to the body of water and the free chlorine and the total chlorine were measured and recorded as a function of amount of DMH in the 300-gallon Marquis Destiny spa. Although Dichlor and DMH were added to the body of water in bulk form, various methods and forms of adding chlorine and the DMH to the body of water may be used, including the use of dispensers and water dissolvable containers.

The test procedure for Example 2 was as follows:

### I. General

1) Recorded all measurements and chemical additions. The chemical additions were made immediately after the measurements were recorded.
2) Chemical additions were made by broadcasting over the surface while all of the jets were running in order to fully mix them throughout the body of water.

### II. Startup

1) Filled with fresh tap water, with softener partially bypassed to give approximately 200 parts per million (ppm) of calcium hardness.
2) Adjusted temperature setting to 85 degrees Fahrenheit.
3) Added sodium bisulfate “pH Down®” to adjust alkalinity into the 80-120 ppm range.
4) Added sodium dichloroisocyanurate-dihydrate “dichlor” to overcome the initial chlorine demand of the water.
5) If needed, adjusted pH into the 7.2 to 7.8 range by running the jets.
6) Measured and recorded temperature.
   III. Free Chlorine vs. DMH Test
1) Adjusted the free chlorine residual to approximately 10 ppm.
2) Measured and recorded chlorine residuals, pH, and total alkalinity.
3) Incrementally increased DMH concentration and recorded residuals and pH.

FIG. 4 shows a table of the results of the measurements of the total and free chlorine in the 300-gallon Marquis Destiny spa as well as the DMH in the body of water. As discussed throughout the disclosure, the results of Example 2 demonstrate that once the equilibrium state is reached, the free chlorine as well as the total chlorine in the body of recreational water was found to remain constant as the amount of DMH is increased. FIG. 5 shows both the free chlorine and the total chlorine in the body of water as a function of the amount of DMH in the water with the level of total chlorine remaining above 9 ppm as the DMH is increased from 1 to 200 ppm. On the other hand, the free chlorine drops to about 0.5 ppm and remains at about 0.5 ppm as the concentration of DMH in the body of water is increased from 20 to 200 ppm.

### Example 3

### Effects of DMH on Protecting Chlorine from UV

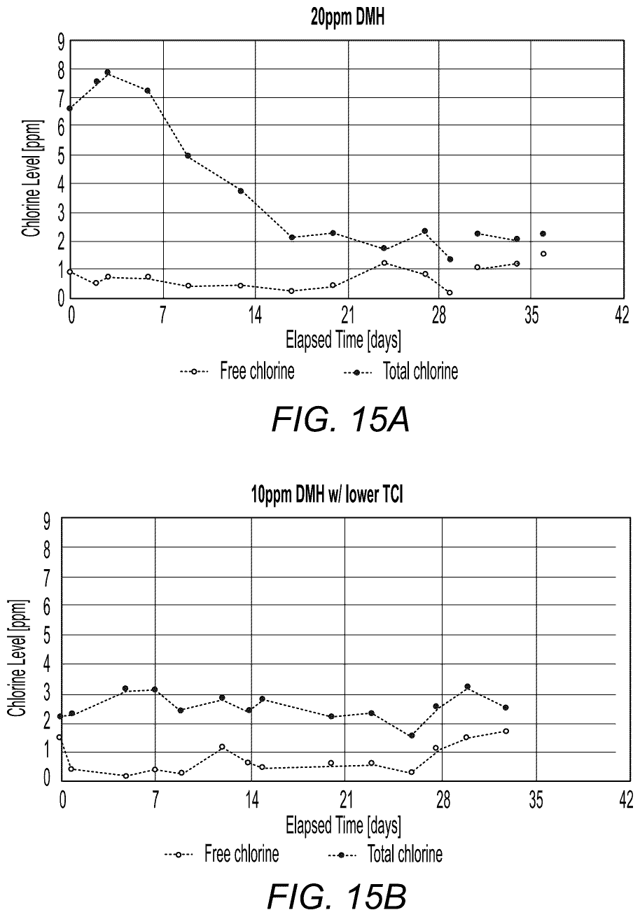

The effects of DMH in a body of water on protecting the water from loss of chlorine due to UV radiation was further assessed. To assess the effectiveness of DMH, a series of water samples were prepared with varying treatments. The water samples included a baseline sample (chlorine only), a DMH sample (chlorine+30 ppm DMH), CYA samples at various concentrations (chlorine+30 ppm CYA; chlorine+50 ppm CYA; and chlorine+75 ppm CYA), and a DMH+CYA sample (chlorine with 30 ppm DMH+30 ppm CYA). The goal was to maintain the total chlorine at a concentration of about 10 ppm. As the test was run over a period of about 4 days, the total chlorine concentration varied between about 8 ppm to about 10 ppm. For some samples, such as the baseline chlorine only sample, the water was recharged with additional chlorine to maintain the total chlorine level at around 10 ppm. The samples were prepared in individual containers and left outdoors to simulate UV exposure. The total chlorine (TCl) remaining in each of the water samples were measured at various times between 0 hours of UV exposure to 7 hours of UV exposure, and a percent of TCl remaining calculated. The results are shown in FIG. 14A.

The free chlorine concentration for water samples containing DMH and DMH+CYA were further evaluated to determine the effects of DMH on the free chlorine level. The water samples included the DMH sample (chlorine+30 ppm DMH) and the DMH+CYA sample (chlorine+30 ppm DMH+either 30 ppm CYA, 50 ppm CYA, or 75 ppm CYA). As shown in FIG. 14B, the CYA concentration was set at about 30 ppm over the time period of 0-10 hours. The CYA was then raised to about 50 ppm over the time period of 20-30 hours and raised again to about 75 ppm over the time period of around 50 hours. The results for each of the data groups are shown in FIG. 14B.

To further determine the effects of UV on chlorine in a water sample, a further analysis was conducted to incorporate data for a water sample without any UV exposure. The total chlorine concentration of various water samples were evaluated from a period of 0 hours to 60 hours, of which about 25 hours had UV exposure. The various water samples included a DMH sample (chlorine+30 ppm DMH) with UV exposure, a DMH sample (chlorine+30 ppm) without UV exposure, CYA sample (chlorine+75 ppm CYA) with UV exposure, and DMH+CYA sample (chlorine and 30 ppm DMH+75 ppm CYA) with UV exposure. All water samples were placed outdoors under the same conditions, with the DMH sample without UV exposure having a raised lid shielding from direct UV exposure but still allowing similar evaporation as the other water samples in the containers. The results are shown in FIG. 14C. The total time period from 0 hours to 60 hours included the hours in which the containers with the water samples were brought indoors overnight, with a lid covering all containers to prevent evaporation and tampering. The containers were brought back outside during daylight hours, which are shown by the data points in FIG. 14C.

As shown in FIG. 14A, the baseline sample with chlorine only (i.e., no treatment with DMH or CYA) demonstrated the effects of UV radiation on TCl concentration. As shown in the graph, UV radiation rapidly reduced and depleted the concentration of TCl within the water sample within 7 hours. However, as shown in FIG. 14A, the sample with DMH treatment provided superior protection of the water sample from chlorine loss due to UV exposure compared to the baseline sample as well as the samples treated with CYA. Unexpectedly, the DMH sample with 30 ppm of DMH clearly outperformed CYA samples with 30 ppm or 50 ppm of CYA within the time period of 8 hours of elapsed sunlight. The DMH sample with 30 ppm of DMH further performed about the same or better than the sample with a much higher concentration of CYA at 75 ppm. To further evaluate the comparison of 30 ppm of DMH to 75 ppm of CYA, a more tailored comparison over a longer period of time was conducted with results shown in FIG. 14C as will be further discussed below. Further, the results demonstrated that a combination of CYA and DMH outperformed the CYA samples at 30 ppm and 50 ppm, and provided similar performance to the sample with a higher concentration of CYA at 75 ppm CYA. The results demonstrated that DMH could be added to a body of water already containing CYA to further increase protection of the body of water from total chlorine loss due to UV exposure. The results demonstrate the unexpected effects of DMH in protecting total chlorine in a water sample from UV radiation.

As shown in FIG. 14B, the results confirmed that the presence of DMH was able to maintain the concentration of free chlorine in the water samples even with UV exposure over a period of 0 to 60 hours. Therefore, not only were the water samples with DMH able to maintain and prevent total chlorine loss from UV exposure, the samples with DMH present were further able to maintain free chlorine in the water sample.

As shown in FIG. 14C, the results demonstrated that the presence of UV does contribute to the loss of TCl concentration in a body of water, further emphasizing the need for a chlorine protector treatment for water sources that may be exposed to environmental conditions, such as UV radiation. Even with the superior effects on TCl protection in a body of water with treatment with 30 ppm DMH, the graph in FIG. 14C shows the even higher concentration of TCl for the DMH sample without UV rays in comparison to the DMH sample with UV rays. Further, as discussed previously with regard to the results shown in FIG. 14A, the results shown in FIG. 14C confirmed that 30 ppm of DMH clearly outperformed CYA at 75 ppm in maintaining TCl levels within the body of water against UV exposure over a longer period of time. Therefore, these results confirm that exposure to UV can reduce TCl concentration, and further demonstrate the superior efficacy of treatments containing DMH, whether alone or in combination with CYA.

### Example 4

### Effects of DMH on Total Chlorine and Free Chlorine

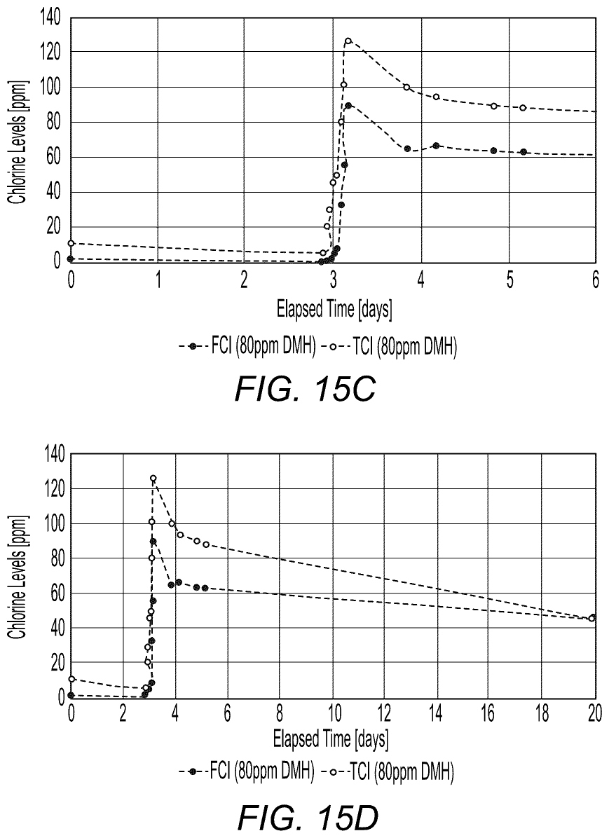

Further analysis was completed to determine the effects of DMH on total chlorine and free chlorine to determine optimal ratio concentrations. For the first analysis, a pool was started at 20 ppm of DMH and about 8 ppm of total chlorine (TCl) which was subsequently lowered to about 2.5 ppm of TCl over a period of days. The presence of DMH was inferred by observing when free chlorine (FCl) spiked and remained above 1 ppm (as DMH will regulate FCl to a range below 1 ppm). The results are shown in FIG. 15A.

As shown in FIG. 15A, the FCl spiked at roughly 4 weeks, just past 28 days. The results demonstrated that with 20 ppm of DMH and between 2.5 to 8 ppm of TCl, the DMH will decompose after about 28 days, as shown by the increase in FCl.

After the 20 ppm of DMH had decomposed from the pool from the first analysis, the same pool was loaded with 10 ppm DMH and the TCl was lowered to about 2 to 3 ppm for the entirety of the testing period. The results are shown in FIG. 15B.

As shown in FIG. 15B, the FCl spiked above 1 ppm at roughly 28 days, which was nearly identical to the case with 20 ppm of DMH. Therefore, the data demonstrates that lowering the TCl could prolong the life of DMH in the system as nearly the same duration period (˜4 weeks) was achieved with half the ppm concentration of DMH by simply lowering the TCl. Therefore, the data further suggests that operating above the saturation limit of DMH at a TCl:DMH weight ratio of 11:20 by adding additional chlorine to the system will cause the additional chlorine to contribute to the FCl concentration and accelerate the decomposition of DMH.

A further analysis was completed to evaluate a higher ratio of TCl to DMH to determine the effects of DMH on FCl levels, as well as the effects of TCl levels on the lifespan of DMH. In this further analysis, a 250 gallon tank was filled with water and 80 ppm of DMH. Heavy loads of bleach were added to the body of water routinely to reach certain TCl levels. Chlorine (via the bleach) was added to the body of water to an initial TCl concentration of about 10 ppm. The TCl concentration proceeded to drop to about 5 ppm over the next 2 days. Chlorine was then added to the body of water throughout day 3 to reach a TCl concentration of about 125 ppm. No further bleach was added beyond this point. The TCl and FCl levels were then measured over a period of about 20 days. The results are shown in FIG. 15C and FIG. 15D.

As demonstrated in FIG. 15C, the FCl level stays relatively low until approaching the theoretical saturation limit of TCl to DMH of about 11:20 (i.e., about 45 ppm of TCl or above). Once the TCl concentration reaches above about 45 ppm, it can be observed that the FCl concentration spikes, and eventually rises to above 40% of the TCl concentration. As further demonstrated in FIG. 15D, as time progressed, the FCl and TCl concentrations were nearly identical at about 20 days, which indicated that there was no more DMH remaining in the system. As described above regarding the data in FIGS. 15A and 15B, a body of water with lower concentrations of DMH at 10 ppm or 20 ppm was able to last about 28 days with chlorine levels less than 10 ppm. In comparison, even with a higher DMH concentration at 80 ppm, a higher TCl concentration accelerated the decomposition of the DMH to last only about 20 days. As such, the data shown in FIG. 15C and FIG. 15D not only demonstrate the importance of the ratio of TCl to DMH, but it also further demonstrates how higher concentrations of TCl affects the decomposition rate of DMH within the water system.

### Example 5

### Regulation of Free Chlorine to Total Chlorine with DMH

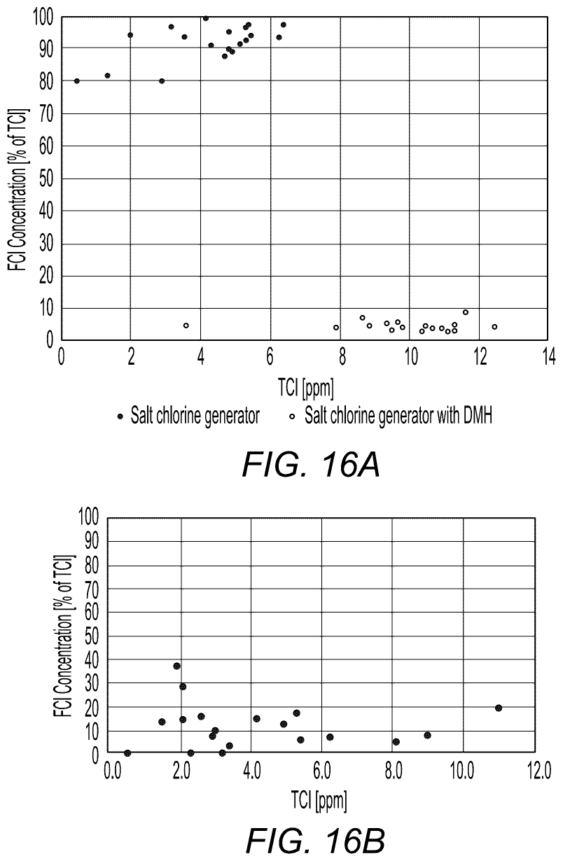

The effects of DMH on the regulation of chlorine was further assessed in various bodies of water. An assessment of the relationship between total chlorine (TCl) and free chlorine (FCl) was evaluated in a hot tub as well as a pool. In the study with the hot tub, the TCl concentration and FCl concentration as a percentage of the TCl concentration was evaluated for a hot tub with a salt chlorine generator, and a hot tub with a salt chlorine generator with 60 ppm of DMH. The results are shown in FIG. 16A.

As shown in FIG. 16A, the hot tub with DMH adjusted the % FCl of the system to around 10% or less, irrespective of the TCl concentration. As shown in the figure, a TCl concentration of 4 ppm resulted in a FCl concentration of less than 10% of the TCl, while a TCl concentration of about 12 ppm further resulted in a FCl concentration of less than 10% of the TCl. However, these same trends were not observed for the hot tub without DMH. For the hot tub without DMH, the FCl concentrations resulted in much higher percentages of TCl.

In the study with the pool, 30 ppm of DMH was added to a pool. Several bleach loads were added to the pool weekly. The FCl concentration as a percentage of the TCl concentration was evaluated at various TCl concentrations. The results are shown in FIG. 16B.

As shown in FIG. 16B, a similar effect of maintaining a lower percentage of FCl can be observed in the pool due to the presence of DMH. In the pool study, the DMH maintained the FCl concentration at 40% or below of the concentration of TCl, regardless of the concentration of TCl. Therefore, the results demonstrate that the use of DMH can maintain the FCl at a concentration of less than about 40% of the TCl level.

The above specification provides a description of the manufacture and use of the disclosed compositions and methods. Since many embodiments can be made without departing from the spirit and scope of the disclosure, the disclosure resides in the claims.

What is claimed is:

1. A method of maintaining a free chlorine level in a body of water when subject to a condition that decreases the free chlorine level, the method comprising:
adding a chlorinating agent to the body of water;
adding 5,5-dimethylhydantoin (DMH) to the body of water; and
maintaining the free chlorine level in the body of water in a range of 0.5 ppm to 1 ppm,
wherein the addition of the DMH to the body of water results in a reservoir of chlorine that converts to free chlorine in the body of water when subject to the condition that decreases the free chlorine level to maintain the free chlorine level in the body of water in the range of 0.5 ppm to 1 ppm.

2. The method of claim 1, further comprising providing a recharging dose of DMH to the body of water.

3. The method of claim 2, wherein the recharging dose of DMH brings a concentration of the DMH in the body of water to at least 10 ppm.

4. The method of claim 1, further comprising maintaining the DMH in the body of water at a concentration of at least 20 ppm.

5. The method of claim 1, wherein the condition that decreases the free chlorine level in the body of water comprises environmental conditions, a periodic bather load, or a combination thereof.

6. The method of claim 1, further comprising a step of measuring the free chlorine level in the body of water, a step of measuring a total chlorine level in the body of water, or a combination thereof.

7. The method of claim 1, wherein the addition of the chlorinating agent to the body of water brings a total chlorine level up to at least 5 ppm in the body of water.

8. The method of claim 1, wherein the chlorinating agent comprises or results from liquid bleach, calcium hypochlorite, trichloroisocyanuric acid, an electrolytic cell that generates chlorine, or a combination thereof.

9. The method of claim 1, wherein a weight ratio of the DMH to the chlorinating agent is at least 0.5.

10. The method of claim 1, wherein cyanuric acid (CYA) is further added to the body of water or is further present in the body of water.

11. The method of claim 10, wherein the DMH increases efficacy of the CYA in the body of water in maintaining the free chlorine level in the body of water in the range of 0.5 ppm to 1 ppm when subject to the condition that decreases the free chlorine level.

12. The method of claim 10, wherein the DMH is added to the body of water at a weight ratio of the DMH to the CYA in a range of about 1:20 to about 10:1.

13. The method of claim 12, wherein having both the DMH and the CYA in the body of water provides a combination that maintains a higher concentration of total chlorine level in the body of water compared with the same body of water when provided with an identical concentration of CYA but without the DMH.

14. The method of claim 5, wherein the environmental condition comprises UV radiation, precipitation, changes in temperature, or presence of organic matter.

15. The method of claim 1, wherein the chlorinating agent comprises or results from an electrolytic cell that generates chlorine, chlorine gas, lithium hypochlorite, sodium dichloro-S-Triazinetrione, or a combination thereof.

16. A method of maintaining a free chlorine level in a body of water when subject to a condition that decreases the free chlorine level, the method comprising:
adding a chlorinating agent to the body of water thereby contributing to a total chlorine level in the body of water;
adding 5,5-dimethylhydantoin (DMH) to the body of water in an initial weight ratio of the total chlorine level in the body of water to the DMH in the body of water in a range of about 1:100 to about 4:5; and
maintaining the free chlorine level in the body of water at a concentration of less than about 40% of the total chlorine level.

17. The method of claim 16, wherein the adding of the chlorinating agent to the body of water occurs before and/or after the adding of the DMH to the body of water.

18. The method of claim 16, wherein the adding of the DMH to the body of water occurs before and/or after the adding of the chlorinating agent to the body of water.

19. The method of claim 16, wherein the weight ratio of the total chlorine level in the body of water to the DMH in the body of water is maintained at about 11:20 or less for decreasing decomposition of the DMH in the body of water.

20. The method of claim 18, wherein cyanuric acid (CYA) is further added to the body of water, or is further present in the body of water.

21. The method of claim 20, wherein the DMH is added to the body of water at a weight ratio of the DMH to the CYA in a range of about 1:20 to about 10:1.

22. The method of claim 21, wherein having both the DMH and the CYA in the body of water provides a combination that maintains a higher concentration of the total chlorine level in the body of water compared with the same body of water when provided with an identical concentration of CYA but without the DMH.

23. The method of claim 16, wherein the condition that decreases the free chlorine level is an environmental condition comprising UV radiation, precipitation, changes in temperature, or presence of organic matter.

24. The method of claim 16, wherein the chlorinating agent comprises or results from liquid bleach, calcium hypochlorite, trichloroisocyanuric acid, an electrolytic cell that generates chlorine, chlorine gas, lithium hypochlorite, sodium dichloro-S-Triazinetrione, or a combination thereof.

25. A method of accelerating decomposition of DMH in a body of water, the method comprising:
adding a chlorinating agent to the body of water containing DMH thereby contributing to a total chlorine level in the body of water, such that a weight ratio of the total chlorine level in the body of water to the DMH is greater than about 1:2;
wherein the adding of the chlorinating agent to the body of water increases a free chlorine level in the body of water to a concentration of greater than about 25% of the total chlorine level.

26. The method of claim 25, wherein the decomposition of DMH in the body of water is accelerated in order to increase efficacy of a biocidal treatment applied to the body of water.

27. The method of claim 26, wherein the biocidal treatment comprises shocking the body of water.

28. The method of claim 25, wherein CYA is further added to the body of water or is further present in the body of water.

29. The method of claim 25, wherein the chlorinating agent comprises or results from liquid bleach, calcium hypochlorite, trichloroisocyanuric acid, an electrolytic cell that generates chlorine, chlorine gas, lithium hypochlorite, sodium dichloro-S-Triazinetrione, or a combination thereof.
